(19) United States
(12) Patent Application Publication
(10) Pub. No.: US 2016/0371394 A1
(43) Pub. Date: Dec. 22, 2016

(54) INDOOR LOCALIZATION USING CROWDSOURCED DATA

(71) Applicant: The Governing Council of the University of Toronto, Toronto (CA)

(72) Inventors: Shervin SHAHIDI, Toronto (CA); Shahrokh VALAEE, Toronto (CA)

(21) Appl. No.: 14/745,873

(22) Filed: Jun. 22, 2015

(51) Int. Cl. G06F 17/30; H04B 17/318; H04W 4/02

(52) U.S. Cl. CPC G06F 17/30958; G06F 17/30061; H04W 4/028; H04B 17/318

(57) ABSTRACT

Methods and systems for generating a map for indoor localization. Raw data traces from a plurality of mobile devices are merged to generate a single data graph. The raw data traces represent paths traversed by the mobile devices and include received signal strength (RSS) fingerprints associated with relative points along the paths. The data graph is matched with a predefined ground truth graph defining physical coordinates of traversable paths. A radio map is generated including both the defined physical coordinates and RSS fingerprints associated with the physical coordinates.

### FIELD

The present disclosure is related to methods and systems for indoor localization. In particular, the present disclosure is related to methods and systems that use crowdsourced data to generate a map for indoor localization.

### BACKGROUND

Although the problem of localizing wireless mobile sensor nodes has attracted attention, designing a real-time and efficient solution for an indoor area is still a challenging problem. The recent attention attracted by indoor localization may be due to the various emerging location based services (LBS) that can only be provided by knowing the user's location, specifically in indoor areas. According to a study in the 1990s, it is reasonable to assume that more than 80% of a human's life is spent in indoor areas [11, 52].

The indoor localization problem differs from that of outdoor settings for at least two reasons: firstly, global positioning system (GPS) which is a commonly acceptable solution for outdoor environments is not available indoors due to lack of line-of-sight; secondly, the common triangulation and trilateration techniques for outdoor localization tend to perform poorly in indoor areas due to the heavy multi-path and fading-in complex structures of the buildings.

### SUMMARY

In some examples, the present disclosure describes methods and systems for generating a map for indoor localization based on two general techniques: received signal strength-based localization and dead reckoning. The system may be trained by using collected data via crowdsourcing, to generate a semantic map that is an aggregation of the raw crowdsourced data, and this collection of data and generation of the semantic map may require little or no active human intervention.

In some examples, the present disclosure also considers the problem of translating topological indoor localization to geological localization, by modeling the floor plan and the semantic maps as graphs. The present disclosure also describes example graph matching algorithms that may be used to merge the crowdsourced data to make a unified data graph, in an unsupervised (i.e., with no human intervention) fashion.

The present disclosure also describes an example node similarity measure based on finding the minimum distance between all sets of permutations of two vectors. An example algorithm to calculate the similarity measure is described also in the present disclosure.

In some examples, the present disclosure provides a method for generating a map for indoor localization. The method may include: receiving a plurality of raw data traces from a respective plurality of mobile devices, the raw data traces representing paths traversed by the mobile devices and including received signal strength (RSS) fingerprints associated with relative points along the paths; merging the plurality of raw data traces to generate a single data graph having a first plurality of nodes connected by a first plurality of edges; matching the data graph with a predefined ground truth graph defining physical coordinates of traversable paths, the ground truth graph having a second plurality of nodes connected by a second plurality of edges; and generating a radio map including both the defined physical coordinates and RSS fingerprints associated with the physical coordinates.

In some examples, the present disclosure provides a system for generating a map for indoor localization. The system may include a processor configured to execute instructions to cause the system to: receive a plurality of raw data traces from a respective plurality of mobile devices, the raw data traces representing paths traversed by the mobile devices and including received signal strength (RSS) fingerprints associated with relative points along the paths; merge the plurality of raw data traces to generate a single data graph having a first plurality of nodes connected by a first plurality of edges; match the data graph with a predefined ground truth graph defining physical coordinates of traversable paths, the ground truth graph having a second plurality of nodes connected by a second plurality of edges; and generate a radio map including both the defined physical coordinates and RSS fingerprints associated with the physical coordinates.

In some examples, the present disclosure provides a method for gathering received signal strength (RSS) fingerprint data. The method may include: while traversing a path, detecting a RSS fingerprint; absent a predefined starting point of the path and absent information about an orientation of the system relative to the path, determining a relative position along the path associated with the RSS fingerprint, the relative position being determined based on cumulative displacement and heading direction relative to a relative starting point; repeating the detecting and determining until an end point is reached; generating a raw data trace including all detected RSS fingerprints associated with respective relative points along the path; and transmitting the raw data trace to a central server.

### BRIEF DESCRIPTION OF THE DRAWINGS

Reference will now be made, by way of example, to the accompanying drawings which show example embodiments of the present application, and in which:

FIG. 1 illustrates an example of how a ground truth graph may be converted to a macro graph;

FIG. 2 illustrates an example of a crowdsourced data graph, with and without heading information;

FIG. 3 illustrates an example of a simulated ground truth graph and its simulated noisy data graph;

FIG. 4 shows an example histogram of the ratio of estimated scale factor to the correct scale factor for example simulated graphs;

FIG. 5 illustrates an example of matching a crowdsourced data graph to a ground truth floor plan;

FIG. 6 schematically illustrates an example hidden Markov model graph matching algorithm;

FIG. 7 is a chart representing an example mapping table;

FIG. 8 illustrates an example simulated ground truth graph and its simulated data graph;

FIG. 9 is a chart representing an example mapping table for the graphs shown in FIG. 5;

FIG. 10 is a schematic illustrating an example system suitable for implementing examples of the present disclosure; and

FIG. 11 is a schematic illustrating a processing unit suitable for implementing examples of the present disclosure.

Similar reference numerals may have been used in different figures to denote similar components.

### DESCRIPTION OF EXAMPLE EMBODIMENTS

To assist in appreciating the present disclosure, a brief discussion of conventional localization approaches is first provided.

Some conventional approaches try to address indoor localization via one or a combination of three common approaches: trilateration and triangulation, such as time-of-arrival (TOA) [13] which best suits open environments and outdoor settings; proximity sensors, such as radiofrequency identification (RFID) tags [14] which have limited applications; and received signal strength (RSS) based fingerprinting (also known as Scene analysis [19]). These approaches tend be based on unique patterns of surrounding signal intensities in the building to locate the user [2, 16].

Some attempts have been made to reduce the training phase efforts for RSS-based techniques. Some of these works suggest using semi-supervised learning algorithms, rather than supervised algorithms, to reduce the amount of needed labeled data for training by exploiting information of unlabeled data, i.e., RSS readings from the building with no physical location tag. Some examples are described in [8, 20].

Other approaches suggest using a combination of other localization techniques to help overcome the issues of RSS-based methods, such as reducing the costs of collecting labeled data for calibration phase, such as [31, 21, 28].

Some works have proposed to overcome the localization problem via simultaneous localization and mapping (SLAM) [26, 9]. These systems usually apply sensor fusion on inertial sensors and RSS fingerprints. SLAM may enable a reduction in the need for human intervention. It may also bring the possibility of using crowdsourced data for building a location's radio map.

Crowdsourcing is a possible approach to tackle the scalability problem of localization systems [15, 26, 33, 22]. Crowdsourcing can be beneficial to RSS-based methods, since the training phase cost for generating the radio map typically makes it unscalable. In such systems, each sensor (or user) contributes to the training dataset by collecting data from a part of the whole area, i.e., its own movement data trace. The collected data are then matched and merged, similar to pieces of a puzzle, to obtain a semantic pathway map, that represents the passable areas of a building.

However, a semantic pathway map is generally scale- and direction-free, and matching such a semantic map to the actual floor plan for obtaining physical coordinates is often not addressed well in conventional approaches, is too complex, and/or requires manual input to find a proper direction and scale to fit the map to the floor plan. For example, [26, 25] obtain such semantic maps using smartphones. [22, 21] use particle filters to limit the pathways into passable areas. Unfortunately, particle filters are typically too complex since each particle should be updated at every step, while the process is typically done in the operation phase of the system (in contrast with the offline calibration or training phase). In [33], multidimensional scaling (MDS) is used to convert the pathway maps to the floor plan. But since the result for the 2 or 3 dimensional space obtained from MDS is not necessarily unique, the two relaxed maps are not necessarily similar, and hence there is a possibility of not obtaining a meaningful response.

Overall, in conventional approaches, the main concentration is usually not on the calibration or training phase, but on the operation phase of the system and its accuracy, possibly on a semantic map. However, after generating the semantic maps from sensory information, matching the floor map to the semantic map and the accuracy of such matching typically is not considered or investigated well in conventional approaches.

As micro electro-mechanical systems (MEMS) technology become more commonly available on mobile devices, such as smartphones and other multipurpose communication devices, inertial navigation systems (INS) have become more feasible. INS locate the user by finding the displacement from the starting point, often by counting the steps and estimating the heading direction of the user (also known as dead reckoning (DR)) [23, 31, 26]. Various examples of the present disclosure may make use of these technological improvements.

The present disclosure, in various examples, describes the calibration or training phase of the indoor localization method and system. In some examples, the present disclosure may aim for a practical system, with little or no need for human supervision or extra infrastructure, and making only minor assumptions about the environment or the users.

In some examples, the present disclosure provides methods and systems for indoor localization that are trained in an unsupervised manner via crowdsourcing. In some examples, each mobile device (e.g., smartphone) user can both use the disclosed system and also contribute to the training data for other users. The user may be allowed to hold the phone in various possible gestures and make occasional stops during his walk. Once enough unsupervised training data is collected in the training phase to generate a reliable radio-map, any suitable localization technique can be employed in the operation phase of the system. The present disclosure will not focus on operation phase accuracy, as any suitable technique may be used.

In the present disclosure, the floor plan and the collected user traces may be modeled as graphs. A graph matching problem may be defined, not only to generate the pathway map of the users via crowdsourced data, but also to automatically match the obtained pathway map to the known floor plan with acceptable accuracy. The present disclosure presents an example graph similarity measure and an example method to calculate it, along with example graph matching algorithms.

Although described in the context of graph matching for use in indoor localization techniques, the example disclosed graph similarity measure and graph matching techniques may not be limited to such application and may be applied (with suitable modification if necessary) to any two graphs with similar settings. For example, they may be applied to obtained pathway maps of related works to translate the topological localization (finding location on the semantic pathway map) to geological localization (finding the location on the indoor map), as well as improving the accuracy of the pathway map.

In some examples, the present disclosure discusses RSS fingerprinting methods for indoor localization, for example using Wi-Fi signals, since they provide acceptable accuracy with little or no need for extra infrastructure installment in an indoor area. Conventionally, such techniques often suffer from the need for time and effort during the calibration phase (also referred to as the training phase). In this phase, a trained technician is conventionally required to gather signal fingerprints of the area of interest, and tag each fingerprint by its physical location. These points are called “labeled data”. The collected labeled data is then populated in a data structure known as the radio map, which is the main ingredient for training the localization system. In some examples, the present disclosure provides an approach to reduce or remove the training phase efforts of RSS based methods using DR.

The same or similar technique can also be used in the online phase to track the user's location, while the drift error of DR may be limited using RSS-based locationing, as in ([22, 24]).

In some examples, DR may be implemented using only accelerometers and gyroscopes embedded in a mobile device. Use of a magnetic field sensor may be avoided, due to the high disturbance of magnetic fields in indoor areas.

The challenge of indoor localization may be modeled using graph theory. More detailed definitions and properties of graphs can be found in graph theory references, e.g., [30, 4].

A graph G=(V,E) is an ordered pair of two sets, where V is a set of vertices (also called nodes) and E is a set of edges. For a directed graph, each edge is an ordered pair of vertices e_{v1,v2}=(v₁,v₂), v₁,v₂ ε V, where in an undirected graph, e_{v1,v2} ε E implies e_{v2,v1} ε E.

An edge-weighted graph, or simply a “weighted graph”, G=(V,E,W) is a graph with a set of values w associated to each of its edges, such that w_{ei,j} ε W, ∀e_{i,j} ε E. For simplicity, the weight w_{ei,j} may be denoted as w_{i,j}.

“The shortest path” problem on a weighted graph is the problem of finding a path between a pair of vertices, such that the sum of the weights of the edges along the path is a minimum.

The problem may be formulated by modeling two graphs: the ground truth graph which is predefined (e.g., known beforehand or otherwise created offline), based on the floor plan, and the data graph, which is built in an unsupervised fashion, based on the readings obtained from users walking in the environment.

As mentioned above, a radio map is used for RSS-based localization, which includes a dataset of RSS fingerprints, tagged with their physical coordinates (labeled points). In examples of the present disclosure, instead of manually building such a dataset, a graph is first defined, which may be called the ground truth graph G_{T}, that only contains the physical coordinates of specific points. Such a graph can be built relatively easily using a graphical interface and a given floor plan. These points have physical location labels, but no RSS fingerprints. Therefore, a second graph may be built from crowdsourced data. The second graph, which may be called the data graph G_{D}, is collected while the users with unknown absolute locations are walking in the building, for example while engaged in their regular daily activities. While the users walk, RSS samples with unknown physical locations are collected and merged into G_{D}. G_{D} has the RSS information but no absolution geological location information. Once both G_{T} and G_{D} are obtained, a graph matching algorithm (e.g., as described in the examples herein) may be applied to find a correspondence between the nodes of G_{T} and G_{D} based on their topological structure and yield a set of points with both physical coordinates and RSS samples, i.e., the radio map.

In order to model the building map as a graph, the floor plan may be discretized by considering the walkable areas as the edges of a graph. The vertices of the graph may be considered as the joints to connect the edges. In other words, the walkable areas in the floor plan may be modeled by rods and joints, considered as the edges and vertices (or nodes) of a graph. In order to reduce the complexity of the model, the angles in which the rods can join may be limited to 4 (i.e., allowing only horizontal and vertical edges). In other examples, increasing the number of angles to 8 possible angles may allow tracking of diagonal movements in the building, such as when large hallways exist and/or when the building has hallways intersecting at angles other than right angles. More or less possible angles may be used, depending on the desired complexity of the model and desired precision of the graph.

The set of labeled points, L, may be defined to be the set of vertices of a graph, representing the floor map. The set of edges e_{i,j} ε E, where i,j ε L is also defined as the ordered path (i,j) if one can walk from i to j without passing through any other graph vertex.

The Euclidean distances between two labeled points on the floor may be defined to be the weight of edges connecting two points, such that w_{i,j}=√((xᵢ−xⱼ)²+(yᵢ−yⱼ)²), where xᵢ and yᵢ denote the physical coordinate of the labeled point i on the floor, according to a given coordinate origin. The resulting weighted, undirected graph may be denoted as the ground truth graph G_{T}=(L,E,W).

The resulting graph may be used not only to build the radio map in the training phase, but also can be used for tracking (e.g., to limit the error of locationing using the movement trace of the user) and/or navigation (e.g., to show the shortest path to the destination) in the operation phase of the system.

In order to build the data graph, the points need to be recognized and defined as vertices. Note that due to the unsupervised nature of the problem, the location information is not available. However, DR may be used to find the relative distance of the vertices, as well as RSS information to distinguish the loop closures and repetitive points.

The process of using unlabeled RSS data to find loop closures and repetitive points may be similar to the operation phase of localization systems with a data set of labeled data, except that in this case instead of finding the physical location of the user geologically, only matching unlabeled points (i.e., repetitive points) are found and merged. This process can be considered as topological localization on the data graph, since no physical coordinate is obtained. The details of building the data graph based on walked data traces are discussed further below.

Consider the set of merged unlabeled points U for the floor map, that is expected to cover the whole walkable floor area or a sub-region in that area. Calling such unlabeled points as the vertices vᵢ^{D}, i ε U, the edges e^{D}ᵢⱼ ε E^{D} may be defined to exist between the vertices if there exists a direct walkable path between those points. The graph G_{D}={U, E_{D},W^{D}} is defined to be weighted, with weights wᵢⱼ^{D} equal to the relative distance between i,j, i.e., the distance from i to j.

The resulting graph will form a chain in a hallway, and a grid in big rooms (where the grid estimates the paths inside the room). Also note that the relative distance between two points can either be a distance vector (having both magnitude and angle information) or a distance scalar (having the magnitude information only). In the present disclosure, for the sake of keeping the generality of the problem, both cases have been considered, with or without angle information, since some mobile devices (or wireless mobile sensors) may not be equipped or configured to provide angle information.

As mentioned above, the edge weights of G_{D} (the distances) and the heading directions are calculated based on a DR module, which is discussed further below. A discussion of how the two graphs G_{T} and G_{D}) are built will now be provided.

As mentioned earlier, G_{T} may be generated by discretizing the floor plan and defining a graph on the floor, based on passable/impassable areas.

Note that according to this definition, the number of nodes along a hallway could vary arbitrarily and is not necessarily equal to the number of nodes on the corresponding hallway in G_{D}, with the result that G_{T} and G_{D} may generally look different. Therefore, in the matching phase, in order to deal with the possibility that there may be an unequal number of nodes, G_{T} and G_{D} may be both filtered so that only the nodes representing turns, intersections, or leaf nodes are considered in the matching. The graph containing only such filtered nodes may be referred to as a macro graph. Note that since detecting sharp turns requires heading direction information, for the cases that such data is not available, the macro graph may only contain intersections points and leaf nodes on both G_{T} and G_{D}. After filtering, the matching would be more robust to the unequal number of nodes since the macro graphs for both G_{T} and G_{D} are expected to look very similar.

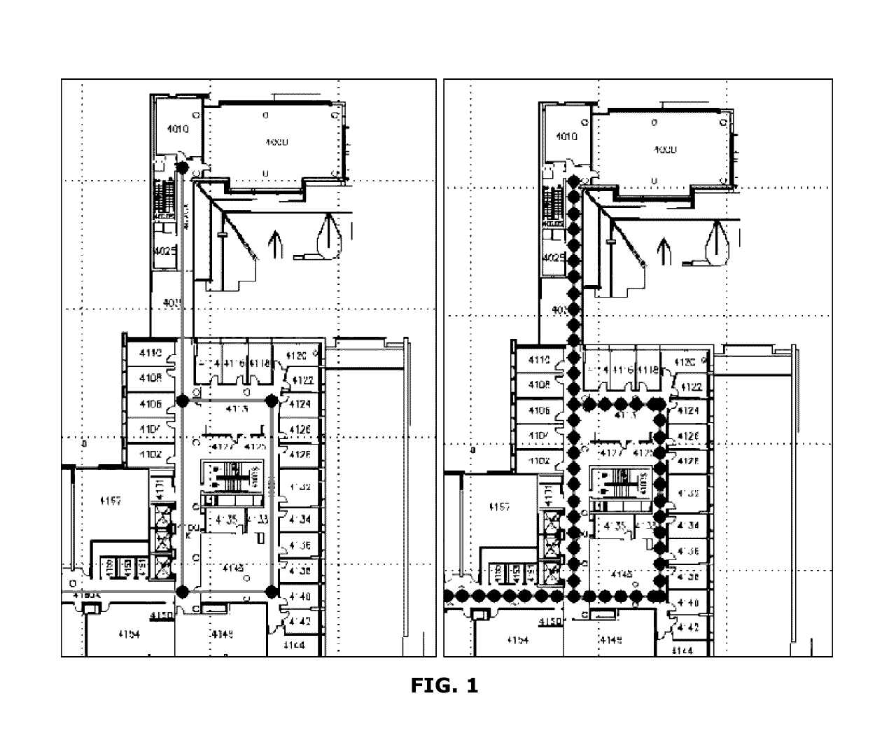

FIG. 1 (right) shows an example ground truth graph generated for a part of a building floor, and FIG. 1 (left) shows an example corresponding macro graph containing only the representative nodes of the graph. Once the graph is generated, its adjacency matrix, along with the location of all nodes may be stored for the matching phase.

In order to build G_{D}, crowdsourced data may be used. When each user walks through the pathways of the building, the user's mobile device collects and stores information about the status of the device and the environment. For example, a DR module, described further below, may count the steps and detect changes in the heading direction of the user. As a result, the user's walking trace can be recorded with respect to an initial point with an initial heading direction. It should be noted that this initial point and initial heading may be any point and heading, and does not need to be pre-specified or manually inputted.

In some examples, collection of trace data may be initiated automatically by the device. For example, the DR module (or other function programmed into the device) may be already active on the device, may detect the user's entrance into a building using GPS signals (since the user's location outdoors, right before entry into the building, is available via GPS) and may automatically initiate collection of trace data on the device, possibly even without the user's knowledge. Alternatively or additionally, the user may input instructions (e.g., select a soft button or invoke an application on the device) to activate collection of trace data. Similarly, collection of trace data may end automatically, such as when the device again detects GPS signals showing the user's location is out of the building. Alternatively or additionally, the user may input instructions (e.g., select a soft button or deactivate an application on the device) to end collection of trace data. It should be noted, particularly when trace data collection is initiated and/or ended by user input, that that start and end points of the trace may not be at any defined or expected point (e.g., entryway) on the floor plan.

While collecting trace data, the DR module may enter a sleep mode, where data collection and Wi-fi scanning may be paused or at longer intervals, when no user movement is detected for a predetermined length of time (e.g., user stays still for 10 min or more). This may help to conserve energy on the device. In some examples, collection of trace data may be automatically restarted after a predetermined amount of detected steps or predetermined amount of time. This means that instead of collecting a single long trace, the DR module may instead collect a series of shorter traces that cover the same path. This may be useful to help reduce or avoid accumulation of drift error, for example.

While such a trace is being calculated, available RSS samples may also be detected and stored, and each RSS sample may be assigned to its relative displacement with respect to the starting point of the walking trace. Once the user reaches the destination (which also does not need to be pre-specified or manually inputted) and stops walking, the data collection may end. Each obtained trace can be considered as a graph with a node at each k taken steps and edges connecting the consecutive nodes, with k indicating the density of graph nodes. In the present disclosure, the terms “traces” and “graphs” may be used interchangeably, for ease of explanation.

After collecting a sufficient number of traces, they may be merged to build a unified data graph. A sufficient number of traces may be a number that ensures most or all of the floor plan has been covered by at least one trace. However, for higher accuracy (since some traces may have data error), a sufficient number of traces may be considered a number that ensures most or all of the floor plan has been covered by at least a predefined number of traces (e.g., at least three traces). In some examples, merging of the traces into the unified data graph may be performed as each trace is collected and transmitted to the server, rather than waiting until a sufficient number has been collected. The merging of each trace may be performed iteratively (e.g., using the method described below), and after each merging the resulting data graph may be checked to see if the floor plan has been sufficiently covered.

Note that the traces do not have any information about the actual map locations in the building, since each trace may be stored with position and heading information defined relative to a different starting point and initial heading direction.

Therefore, to merge two traces G₁=(V₁,E₁) and G₂=(V₂,E₂), it is necessary to use a common coordinate system, such as by transforming one to the other one's coordinate system. All the node coordinates of G₂ may be transformed to the coordinate system of G₁ (or vice versa). The transformation may entail finding a proper origin offset O=[α, β]^{T}, a rotation matrix R_{2×2}, and scale factor S=s×I_{2×2}, which can be described via the following relation:

$$\begin{matrix}{v}^{′} = S \times R \times v + O \\ = [ \begin{matrix}s & 0 \\ 0 & s\end{matrix} ] [ \begin{matrix}cos θ & sin θ \\ - sin θ & cos θ\end{matrix} ] [ \begin{matrix}{v}_{x} \\ {v}_{y}\end{matrix} ] + [ \begin{matrix}α \\ β\end{matrix} ] ,\end{matrix}$$

where θ is clockwise rotation angle between the coordinate system of the two traces.

In some examples, for simplicity and due to observations, the scale factor may be considered to be 1. Therefore, the only remaining transformation parameters to estimate are θ, α and β.

To find the transformation parameters, the collected RSS values in the nodes of two traces may be compared. Finding the similarity (which may be quantified as a distance) of two RSS readings may be performed using various suitable methods; for example, a suitable method may be comparing the Lₚ norm of the difference (with p usually 1 or 2) as in [33, 32]. For each two RSS samples fᵢ, fⱼ, the union of visible access-points (AP) is determined and the norm-p distance of the two RSS vectors is calculated. For each AP that is only visible in one of the points, a penalty is added to the distance by replacing the invisible AP RSS values to be a very small received power (e.g. −110 dbm which indicates no signal in Wi-Fi standard). The distance is then normalized based on the number of common APs. Since having more common APs indicates a higher chance of having corresponding nodes on the two traces, the normalized distance is then rewarded (decreased) with a concave function of the count of common APs, since concave functions are more distinctive among small amounts of common APs. In examples of the present disclosure, the log function may be used for the rewarding scheme. Therefore, the overall distance can be calculated via the following relation:

D(fᵢ,fⱼ)=∥fᵢ,fⱼ∥ₚ/n−log n,

where n is the number of common APs and the invisible APs are set to have the RSS value −110 dbm.

Once the distance of all RSS sample pairs of G₁ and G₂ are calculated, a suitable matching algorithm, such as the stable matching algorithm (described further below), may be used to assign the points of G₁ to corresponding points in G₂. If the distance of the two points is less than a threshold, the assigned points from the two traces are considered to be on the same physical location indicating an overlap between the two traces. Given 3 or more overlapping points, the parameters θ, α and β are calculated. The traces that do not have enough overlap are kept to be compared again later, when more traces are merged. In some cases, if, at the end of the training phase, there remains one or more traces that are not merged, those traces may be discarded (e.g., to save on server memory).

Define an ordered set of overlapping points in G₁ as P₁ and their corresponding points in G₂ as P₂. The offset O=[α, β]^{T} is calculated by finding the minimum mean square error (MSE), as follows:

$$[ \begin{matrix}α \\ β\end{matrix} ] = [ \begin{matrix}\frac{1}{\vert {P}_{1} \vert} {\sum }_{i = 1}^{\vert {P}_{1} \vert} ( {{P}_{1} ( i )}_{x} - {{P}_{2} ( i )}_{x} ) \\ \frac{1}{\vert {P}_{1} \vert} {\sum }_{i = 1}^{\vert {P}_{1} \vert} ( {{P}_{1} ( i )}_{y} - {{P}_{2} ( i )}_{y} )\end{matrix} ] .$$

In the example described here, the rotation angle θ is hard limited so that it can only be a multiple of 90 degree turns (for the 4 possible heading directions). It is straightforward to extend the algorithm to include turns at 45 degree angles (e.g., where 8 possible heading directions are considered), or other desired angles. In this example, it can be calculated by trial and error over the four possible rotation matrices of 0, 90, 180, and 270 degree rotation, and picking the rotation angle that obtains the minimum MSE after removing the offset.

Once the second trace is transformed to the coordinate system of the first trace, the traces can be merged. The traces may be merged based on their distance in the physical domain. In other words, each two points from the two traces are merged if their Euclidean distance is less than a threshold. Once each two points are merged, their location, neighborhood information, and RSS values are also merged.

In order to merge the location coordinates and RSS values, a dynamic weighted averaging method may be used. Let a data entry (e.g., a node location or an RSS value) D_{W} be a weighted average of W previous samples. Define the new data entry being merged (W+1-th entry) by d_{new}. The resulting average value for the data entry D_{W+1} is defined to be

$${D}_{W + 1} = γ ( \frac{{WD}_{W} + {d}_{new}}{W + 1} ) + ( 1 - γ ) ( \frac{{D}_{W} + {d}_{new}}{2} ) , \qquad ( 1 )$$

where 0≦γ≦1 is a forgetting factor that keeps the data set up to date by taking a weighted sum of an averaging term that uniformly values all the W+1 merged data entries (first term) and an averaging relation term that assigns half of the weight to the most recently merged entry (second term). Note that using the averaging method in (1), at the early steps when the merged data graph and the newly found trace are both unconfident, say W=1, both of the points will have a similar weight in the averaging. As the number of merged points grows, W grows bigger and the weight goes more toward the merged data graph. On the other hand, because of the γ factor, the old data values will be forgotten during the long run.

The result of such merge is a single data graph, with the information from both of the traces. The obtained graph is then used as the incomplete data graph for the next trace to be merged with. The merging continues until all traces are merged.

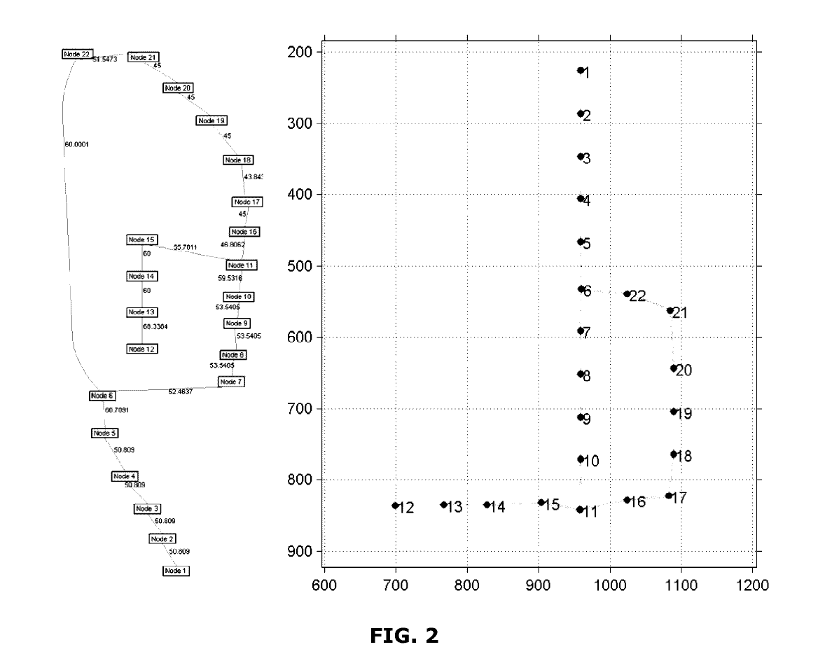

FIG. 2 represent an example built data graph from a part of a building, without heading direction information (FIG. 2, left) and with heading direction information (FIG. 2, right).

In some examples, a suitable DR module used in building the G_{D} may implement a step counter for finding the relative distance between two points and a turn detector, used for finding the changes in the heading direction.

In order to detect and count the steps, the mobile device's accelerometer may be used. Each acceleration sample is a 3-dimensional value a=(aₓ,a_{y},a_{z}), indicating the acceleration in terms of m/s², with respect to the device's coordinate system.

The step counter may be implemented using the acceleration magnitude (i.e., |a|=|aₓ²+a_{y}²+a_{z}²|^{1/2}), which is a scalar value independent of the device's orientation and has the same value, both in the device's and the world's coordinate system. Consequently, the extra complexity of finding the device orientation is avoided, without forcing the user to keep the phone in a predefined orientation.

Note that before detecting the steps, the effect of gravity should be removed from the raw accelerating samples, obtaining linear acceleration which is equal to the sensed raw acceleration subtracted by gravity. Various suitable methods may be used for such a task, such as applying a low pass filter on the sample or combining the information from gyroscope and accelerometer (e.g., using a Kalman filter) to obtain more accuracy and less delay. For example, APIs already implemented on typical Android™ phones may be used [1].

There are various suitable step counter algorithms, based on the readings from accelerometer and gyroscope, that use a variety of patterns to detect the steps, such as detecting the peaks on accelerometer, zero-crossings of the z-axis acceleration, or correlation of the acceleration readings with some step profiles [7, 23]. For example, a peak detector similar to the method in [12] may be used.

The peak detector should be robust to a variety of noise sources to weed out the peaks that were not introduced by actual user steps. For example, the peak detector may only consider the peaks that satisfy the following set of constraints: being the local maximum for a moderate period of time, having a magnitude within a certain range, occurring less frequently than a certain amount, and being surrounded with two valid local minima that have similar constraints. The parameters of such constraints may be tuned experimentally. Table 1 below shows example results indicating the accuracy of the example step counter for different users and device brands, along with 3 possible holding gestures: in-front, swinging, and on the ear. Rows 1 and 2 of Table 1 show example results for swinging and on the ear gestures, while the other rows show example results for in-front holding gesture. Although not shown, other holding gestures may be possible. It may also be possible for the user to change holding gestures while walking.

TABLE 1

| | | Tester | connted | Actual | Accuracy |
|---|---|---|---|---|---|
| # | Phone brand | id | steps | steps | % |
| 1 | Sam. S1 | P1 | 39 | 40 | 97.5 |
| 2 | Sam. S1 | P1 | 85 | 85 | 100 |
| 3 | Sam. S1 | P1 | 60 | 60 | 100 |
| 4 | Sam. G. Tab | P1 | 60 | 60 | 100 |
| 5 | Moto. RAZR. | P1 | 79 | 80 | 98.8 |
| 6 | HTC Des. Z | P2 | 49 | 50 | 98 |
| 7 | LG Nex. 4 | P3 | 98 | 100 | 98 |

Stride length may vary from person to person and even for the same person in different situations.

There are various suitable methods to estimate the stride length, such as manual calibration for each person [12], using heuristic functions of acceleration magnitude [28], and processing the sensor data via Kalman filtering [18].

In the examples of the present disclosure, the concentration is primarily on building the data set via a graph model using graph matching techniques. Therefore, for the sake of simplicity, the stride length of each user may be manually set. However, other suitable methods of estimating the stride length may be used.

Although setting the stride length to a constant value may not be very accurate, it has been demonstrated, as shown in the example results discussed below, that the example matching algorithms of the present disclosure are able to compensate for such inaccuracies effectively.

The gyroscope sensor of the mobile device may be used to find the relative heading direction of the user. The gyroscope measures the angular velocity in 3 dimensions with respect to the device's reference frame. Since the user walks in a plane along the world's horizon (e.g., assuming the user remains on the same floor of the building), the only rotation angle of interest, which is the user's heading, is equivalent to yaw or rotation angle around the Z axis of the world (also known as azimuth). Therefore, the rotations of the device may be decomposed into two orthogonal components: rotation around the world's Z axis, and rotation around some axis in the Y-X plane, i.e., v=v_{Z}+v_{XY}, where v denotes the angular velocity of the device in 3 dimensions, while v_{Z} represents the angular velocity of the device with respect to the world's Z axis.

To find v_{Z}, the angular velocity (e.g., as sensed by the gyroscope) may be projected to the world's Z axis and then integration over time may be performed to obtain the rotation angle. The world's Z axis is provided by the gravity sensor of the device (e.g., calculated from accelerometer), which always provides a 3D vector pointing to the earth's center. Therefore, for each time t

Z(t)=−g(t)/∥g(t)∥,

v_{Z}(t)=Z(t)·v(t),

dθ=v_{Z}(t)dt, [rad] (2)

where g is the gravity vector, Z is the vector pointing to world's Z axis, dθ is the amount of rotation around the world's Z axis during the interval dt.

Since the cumulative displacements of heading direction are subject to drift error, such approach may be suitable only for short durations of time. In order to eliminate the drift, instead of continuous integration and finding the heading direction, a short sliding window of time may be considered and turns may be detected when a user's relative heading direction changes above a threshold. For example, for changes in the heading direction that are between [45,135] degrees, a 90 degree turn may be detected. This example detecting scheme for 90 degree turns was tested on several users, phone brands, different walking paths, and gestures and was found to achieve an average accuracy of 98% on a total of 180 turns in the walked paths.

Next, the matching problem is considered, namely: given two graphs G_{T} and G_{D}, how to find a matching (or partial matching) between the nodes of the two graphs. Note that in this disclosure, to maintain generality, the direction information of the graph in the matching algorithms is not used. However, with suitable modifications, such information can be added to the example algorithm described below, which may help to improve accuracy.

In order to match the two graphs, a similarity (or equivalently dissimilarity) measure between the components of two graphs is required. Then, the components of the two graphs may be compared and the ones with sufficient similarity may be matched.

The notion of similarity between two graphs may be defined differently depending on the specific application. Based on the application, the definition can address a variety of topological characteristics of a graph (c.f. [5]).

In the examples of the present disclosure, the graph structures are relatively specific, since passable areas in most of the buildings are similar, for example they usually have no nodes with degrees higher than 4 (i.e., 4-way intersections) and they usually have a single connected component.

Also note that since the heading direction information is not considered in the matching, the graphs do not have a rigid shape, so that computer vision-based techniques such as template matching methods may not be suitable.

The similarity may be defined based on the vector of all pairs' shortest paths. For a graph G=(V,E) define the vector of all shortest paths from a vertex v as

SP_{G}(v)ε [symbol] ⁿ [symbol] (x₁,x₂, . . . ,xₙ),

xᵢ=shortest path length(v,i), i ε V,

where n=|V| is the number of nodes of G.

Such measure represents each node of the graph with a vector of length |V|. The idea is that each point in the graph is expected to have a unique representative vector.

Therefore, for similar graphs, the corresponding nodes should have the same (or very similar) vectors. Note that the order of the elements of SP_{G}(v) is not necessarily the same in two graphs. Therefore, the dissimilarity (e.g., measured as distance) between two nodes v,w of two graphs is defined to be the difference between the permutation of the elements of v and w that minimizes the Lₚ distance between them, for p≧1:

$${dissim}_{SP} ( v , w ) = {min}_{{π}_{w} ∈ \prod ( {SP}_{{G}_{2}} ( w ) )} {‖ {SP}_{{G}_{1}} ( v ) - {π}_{w} ‖}_{p} , \qquad ( 3 )$$

where π(SP_{G2}(w)) is the set of all permutations of vector SP_{G2}(w).

As an example, for a given p, if SP_{G1}(v)=(1, 2, 3, 4) and SP_{G2}(w)=(3, 1, 2, 5), then according to the definition dissim_{SP(v,w)}=|1|ₚ=1. For the cases where the size of two vectors x and y are not the same, the similarity is defined for a subset of x and y of size min(|x|,|y|) that minimizes the sum given in (3). Note that (3) refers to a dissimilarity measure. However, for ease of explanation, the values may be referred to as similarities rather than as dissimilarities.

In order to calculate the similarity based on all pairs shortest path, consider the following theorem:

THEOREM 1. For two vectors x, y with length n and p≧1

$${min}_{{π}_{y} ∈ Π ( y )} {‖ x - {π}_{y} ‖}_{p} = {‖ sort ( x ) - sort ( y ) ‖}_{p} , \qquad ( 4 )$$

where sort(.), denotes a permutation of the elements of a vector, that is sorted in increasing order.

Using Theorem 1, the computational complexity for calculating the dissimilarity between two nodes via this measure, after finding the shortest path length to all pairs of nodes in the graph, requires sorting the two shortest path vectors, which is O(|V|log|V|).

For the cases that |x|<|y| (or vise versa), it has been proven that a necessary condition for having an assignment from elements of x to a subset of y with minimum distance, is no ties in the assignment. An assignment of the elements of two sets are defined to have ties if there exists two pair of elements xᵢ, xⱼ and y_{i′},y_{j′}, with xᵢ<xⱼ and y_{i′}<y_{j′}, such that xᵢ is assigned to y_{j′} and xⱼ is assigned to y_{i′}. As a result, for such cases, a search algorithm, can be applied to the sorted elements of x and y to find the optimal subset of y and assign them to elements of y, one by one and in order.

Assuming |x|<|y|, an example suitable algorithm may comprise the following:

1. Sort x and y and initialize i←1.

2. If I<|x|, for the i-th element of x, i.e., xᵢ, find the best match in y; otherwise, quit.

3. If mapping xᵢ to its best match doesn't cause a conflict, then increment i and go to 2. Otherwise:

4. Set the total distance←∞.

5. Temporarily map xᵢ to its closest match that does not cause a tie.

6. Calculate the total distance up to here. If equal to or better than previous total distance, keep the current answer as the best answer. Otherwise, increment i and go to 2.

7. Map xᵢ to the element on the left of its current mapped element.

8. If possible, map all the elements x₁, x₂, . . . , xᵢ₋₁ to the left element of their current mapped element if they are causing a tie and go to 5. Otherwise, (shift to left is no more possible,) increment i and go to 2.

Example Algorithm 1 below illustrates pseudo code of an example implementation of this example algorithm.

Algorithm 1: Optimal assignment of the elements
of two vectors x, y for minimum total Lₚ distance,
with |x| ≠ |y|

| | input : Two vectors x and y with lengths n₁ ≦ n₂, norm |
|---|---|
| | parameter p |
| | output: The minimum Lₚ distance between the elements of |
| | x and all possible subsets of y with size n₁ |
| 1 | x = Sort(x) |
| 2 | y = Sort(y) |
| 3 | define the mapping array M[1...n₁] = [0...0] |
| 4 | best = ∞ |
| 5 | M[1]= argmin(\|x[1] × 1_{1×n}₂ − y\|) |
| 6 | best = (x[1] − y[M[1]])^{p} |
| 7 | for i = 2 to n₁ do |
| 8 | \| inx = argmin(\|x[i] × 1_{1×n}₂ − y\|) |
| 9 | \| if M[i − 1] < inx then |
| 10 | \| \| M[i] =inx |
| 11 | \| \| best = best +\|x[i] − y[M[i]]\|^{p} |
| 12 | \| else |
| 13 | \| \| M[i] = M[i − 1] + 1 |
| 14 | \| \| best = best +\|x[i] − y[M[i]]\|^{p} |
| | \| \| /* look for the best mapping by shifting */ |
| 15 | \| \| temp_M = M |
| 16 | \| \| for j = 1 to |
| | \| \| min(M[i − 1] − inx + 1, M[i − 1] − i + 1) do |
| 17 | \| \| \| temp_M = shiftleft(temp_M) |
| 18 | \| \| \| if Σₖ₌₁ⁱ \|x[k] − y[temp_M [k]]\|^{p} < best then |
| 19 | \| \| \| \| best = Σₖ₌₁ⁱ \|x[k] − y[temp_M [k]]\|^{p} |
| 20 | \| \| \| \| M = temp_M |
| 21 | \| \| \| else |
| 22 | \| \| \| \| break |
| 23 | \| \| \| end |
| 24 | \| \| end |
| 25 | \| end |
| 26 | end |
| 27 | best = best ^{1/p} |

Note that when calling the shiftleft function for resolving conflicts (ties), not all of the mappings will be necessarily shifted; only the ones that are conflicting must be shifted. For example, if we have M=(2,4,5) (meaning that x₁,x₂ and x₃ are mapped to y₂,y₄ and y₅ respectively), in order to shift the elements to left, since there is a gap between 2 and 4, the shifted mapping becomes M=(2,3,4), leaving element 2 unaltered.

To calculate the complexity of the algorithm, the most time-consuming part of the algorithm may be doing the shift left and recalculating the total distance. Since each element is only shifted left until its place in the final mapping is found, the whole assignment only consists of at most |y| shift lefts. To be more exact, for each node, one extra shift left may be performed to find out that more shifts will not decrease the distance and break the loop at Line (22). Therefore, the whole assignment requires at most 2|y|=O(|y|) shift lefts. Since each shift left requires a constant calculation time of at most |x| points, the computational complexity of the Algorithm is O(|x∥y|). Thus, the example pseudo code illustrated in Algorithm 1 optimally assigns each element of x to an element of y with minimum total Lₚ distance, given |x|≦|y| and 1≦p.

After calculating the similarities of node pairs, a similarity matrix SIM is created to match the two graphs. The problem of matching can be considered as an assignment problem, where each node from G_{D} must be assigned to its representative node in G_{T} based on SIM.

According to the problem formulation and the used algorithm, the mapping might be one-on-one or many-to-one.

In examples of the present disclosure, an example algorithm, referred to as K-best fits, may be used along with two other matching algorithms for comparison: stable matching [10] and Hungarian method [17]. The stable matching algorithm and the Hungarian method will be first briefly explained. Afterward, the example K-best fits algorithm, including an example suitable pseudo code, will be discussed.

The stable marriage problem, or stable matching problem, is a problem in which a set of men and women want to marry each other. All men and women have their own list of preference for marrying the opposite gender.

A marriage between m, w is defined to be stable, if two conditions are satisfied: w prefers m to any other man who has proposed to her; and m prefers w to any other woman to whom he could be married (i.e., who would have said yes to him if he proposed).

The problem is seeking for an assignment of men and women, where all marriages are stable.

An optimal polynomial time algorithm for such problem is given by Gale and Shapley in [10] with worst case running time O(V³). It is also proved in there that a stable matching always exists.

However, in the matching described in the present disclosure above, the mapping may not be one-on-one (i.e., |V_{GD}|≠|V_{GT}|). A modification of the algorithm may be made to allow one-to-K mappings, where K is the maximum allowed number of assigned members of W to the set M. As a result, for the cases where the density of the nodes of G_{D} and G_{T} are not the same, the algorithm can still provide meaningful answers. Letting K=1 will reduce the algorithm to the classic version.

The stable matching algorithm is optimal in the sense of providing an equilibrium. However, in the context of matching G_{D} to G_{T} this algorithm misses two facts: first, the nodes that are neighbors in one graph, are most likely matched to neighbor nodes in the second graph. This fact is missed since the stable matching is not aware of the neighborhood information of the nodes. Second, since the similarity matrix is prone to error, the values of similarity should be directly considered in the matching, rather than similarity rankings. Thus, even with modification, the stable matching algorithm may not be best suited for matching G_{T} and G_{D}.

Another matching technique, the Hungarian method [17], is an algorithm for addressing the maximum weighted bipartite graph matching problem, also known as the assignment problem. Given a set of tasks and a set of workers with different costs for doing each task (e.g., a cost matrix), this algorithm finds the optimal assignment of tasks to the workers in the sense of minimizing the total cost.

A common implementation of the Hungarian method that is efficient for sparse graphs (O(V²E)) is given in [6]. This method has been commonly used in different areas for matching components of two objects, e.g., in shape matching and object recognition [3].

To use this algorithm, the matching of G_{T} and G_{D} may be defined as an assignment of the nodes of G_{T} to G_{D} with a given similarity matrix SIM, and the solution is to find the assignment with maximum total weight.

Unlike the stable matching algorithm, here the similarity values (rather than the similarity rankings) are used. Therefore, as will be seen in the example results discussed further below, the Hungarian method was found to outperform the stable matching algorithm. However, the Hungarian method is more complex than the stable matching and still does not use the neighborhood information of the nodes. Thus, the Hungarian method also may not be best suited for matching G_{T} and G_{D}.

In order to use the similarity values between the graphs, as well as the neighborhood information of the nodes within each graph, the present disclosure provides an example algorithm, referred to as the K-best fits algorithm, that iteratively matches the nodes and incorporates the neighborhood information of the matched points as the assignment of nodes is being completed.

The algorithm traverses the graph G_{D} in a breadth first fashion (similar to BFS graph traversal algorithm), starting with a random node. Therefore, a sequence of visits is made, with each node having a predecessor in the visit sequence. When a node is being visited, “the best K matches” of that node is selected in G_{T} and added to the K-best mappings. The final answer is obtained when all nodes of G_{D} are visited. According to the example implementation, one-to-many mappings may or may not be allowed.

A factor about this algorithm is in the way “the best K matches” are selected. For each node v, the best K matches may be selected not only based on the similarity matrix, but also based on the distance between v and its predecessor pre(v). To be more specific, if the distance of v from pre(v) is d, the distance of matches of v to the matches of pre(v) may be expected to be also close to d. Therefore the similarities between v and each node u ε G_{T} is decreased with a penalty kernel f(|D_{GD}(v,pre(v))−D_{GT}(u, Mᵢ[pre(v)])|), where D_{G}(a,b) is the shortest path distance between nodes a and b in a graph G and Mᵢ is the i-th best found mapping before visiting v. Since the K best matches are calculated for v based on the K best mappings for πᵥ, K² resulting mappings will be obtained, where only the best K ones will be kept as the mappings to be used for updating the similarities for the next node being visited.

In some experiments, a linear penalty kernel f(d)=αd was used, where α is a constant factor, set to 1/10. Therefore, the similarity between v ε G_{D} and u ε G_{T} given the i-th mapping, was updated via

sim(v,u)←sim(v,u)−α|D_{G}_{_{D}}(v,pre(v))−D_{G}_{_{T}}(u,Mᵢ[pre(v)])|.

Algorithm 2 below shows an example pseudo code that illustrates this example method in more details.

Algorithm 2: K-best matching

| | |
|---|---|
| input : | similarity matrix S_{n×m}, adjacency matrices |
| | D_{G}_{_{D}}, D_{G}_{_{T}} for graphs G_{D}, G_{T}, all pairs shortest |
| | path matrix P for G_{T}, distance penalty kernel f( ), |
| | and the K value |
| output: | K best found assignments between the rows of S |
| | (elements of V_{G}_{_{D}}) and the columns of S (elements |
| | of V_{G}_{_{T}} |

| 1 | define K empty mappings M_{1...K} of size n | |
|---|---|---|
| 2 | pick a random node v from G_{D} and Enqueue(v) | |
| | /* find the most K similar nodes of G_{T} with head | |
| | according to S | */ |
| 3 | for i = 1 to K do | |
| 4 | \| in Mᵢ[head] = the i-th most similar node in G_{T} to head | |
| 5 | end | |
| 6 | while Q is not empty do | |
| 7 | \| if head has no free neighbors then | |
| 8 | \| \| Dequeue(head) | |
| 9 | \| \| continue; | |
| 10 | \| end | |
| 11 | \| pick a free neighbor of head, v and Enqueue(v) | |
| 12 | \| for i = 1 to K do | |
| 13 | \| \| temp = S[v, 1...m] − f(\|D_{G}_{_{D}} (head, v) − | |
| | \| \| D_{G}_{_{T}} (Mᵢ(head), 1...m)\|) × 1_{1×m} | |
| 14 | \| \| for j = 1 to K do | |
| 15 | \| \| \| fit[i, j] = the total similarity from Mᵢ+ | |
| | \| \| \| similarity of the j-th most similar node of G_{T} | |
| | \| \| \| to v according to temp | |
| 16 | \| \| end | |
| 17 | \| end | |
| | \| /* out of the K² elements of matrix fit, pick the | |
| | \| K first with highest fits | */ |

| | |
|---|---|
| 18 | \| for i = 1 to K do |
| 19 | \| \| Mᵢ = the mapping with the i-th best total |
| | \| \| similarity, including mapping of node v, according |
| | \| \| to fit |
| 20 | \| end |
| 21 | end |

If the algorithm is run N times with N random starting points, the complexity becomes O(NK²V²). In some examples, a proper value for K was observed to be as low as 2 or 3.

The following discussion provides example simulation results comparing the above-discussed approaches for graph matching.

One of the challenges of building the radio map using G_{D} and G_{T} is dealing with different sources of noise and inaccuracy. Issues that may need to be addressed to obtain a reliable result include, for example:

The noise in distance; for example due to inaccuracy of the step counter, step length, or building G_{D}.

The noise in picking up wrong nodes, or repetitive nodes, or missing a node, which may also lead to adding/missing edges. This noise may happen due to imperfect step counting and also in mismatching the trace overlaps when building G_{D}, for example

Difference between the distance unit for the two graphs (a scaling problem).

It may be noted that other than the noise in building the data graph G_{D}, the number of nodes in G_{D} may be generally different from the number of nodes in G_{T}, because of the difference in the process of building the two graphs. Therefore, as discussed above, before calculating the similarities the nodes of both graphs may be filtered to create macro graphs, and the matching may be performed on the macro graphs.

To deal with the difference in the scale of the two graphs, the graph weights may be normalized by the sum of the length of the shortest path between all pairs of nodes in each graph.

It should also be noted that G_{D} might only cover a portion of the whole floor plan (e.g., if the users have not covered all of the building indicated in the building floor plan). To take into account this possibility, the example simulations below also consider the case of partial matching.

One example simulation considers the problem of noise being present in step count and step length. In this example experiment, G_{D} was a noisy version of G_{T}.

In order to validate the performance of the example similarity measure and matching algorithm described in the present disclosure, 1000 simulations were performed on randomly generated graphs. In each round, a random graph was generated with 20 to 60 nodes, after filtering. The ground truth graphs G_{T} were generated by simulating a random 2 dimensional (2D) walk on a 2D plane. The obtained graphs had certain structural limits, such as having maximum node degree of 4, having a single connected component, and being planar, so that the graph could actually be in correspondence with an imaginary building floor. A noisy copy of the graph was also generated when building G_{T} by adding a Gaussian noise (with σ ε {0.05, 0.1} of step size) on each edge weights.

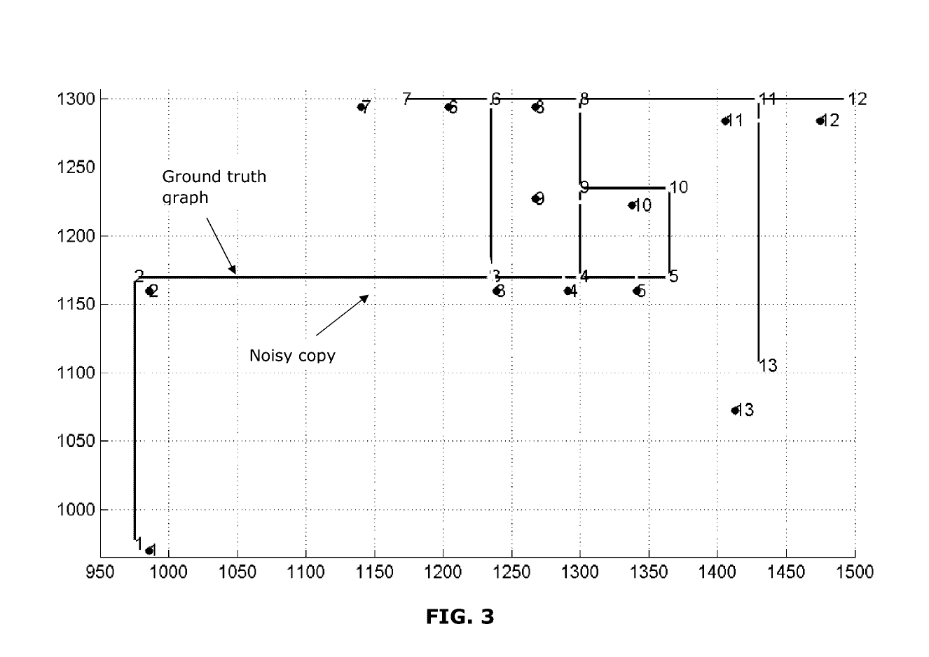

A sample simulated graph and its noisy copy (as data graph) is shown in FIG. 3.

Table 2 below shows the results of the example simulation, along with other real data results that will be discussed later. The example results compare the stable matching (SM), Hungarian method (HM) and example disclosed K-best matching techniques. The results indicate the accuracy (in percentage of correct assignments) of the various matching algorithms and similarity measures. σ is the standard deviation of the noise added to G_{D}.

TABLE 2

| | K-best | SM | HM |
|---|---|---|---|
| Sim. before filtering σ = 0.05 | 95 | 81 | 88 |
| Sim. after filtering σ = 0.05 | 99 | 97 | 99 |
| Sim. before filtering σ = 0.1 | 89 | 69 | 75 |
| Sim. after filtering σ = 0.1 | 99 | 95 | 98 |
| Real data (semi-supervised) after filtering | 100 | 82 | 82 |
| Real data (crowdsourced) after filtering | 88 | 76 | 82 |

It can be seen that although all algorithms perform suitably well due to proper definition of the similarity measure, the example disclosed K-best fits algorithm is found to be more robust to noise than the comparing algorithms. For noise standard deviation σ=0.05, the K-best fits algorithm is observed to match 95 percent of the nodes in the simulated graphs correctly.

It can also be seen that filtering the nodes before the matching, as mentioned above, makes the matching more robust in all 3 algorithms. The filtering also decreases the computational complexity of the problem by a factor, since the number of nodes in the macro graphs is generally less than the number of nodes in original graphs. Once the matching on the filtered graphs is done, the rest of the nodes of the original graphs can be matched easily, based on the matched nodes of the macro graph.

The issue of partial matching was also considered, which may occur when G_{D} is only a part of the ground truth graph G_{T} (e.g., when the entire floor plan has not been traversed by users).

1000 random graphs were again generated, as described above, but only a portion of G_{T} was kept as G_{D}. The example results of the matching algorithms for partial matching with randomly generated graph with 60 to 100 nodes before filtering, are shown in Table 3 below. The results are indicated in percentage of correct assignments. σ is the standard deviation of the noise added to G_{D}. It can be seen that the example disclosed K-best fits algorithm has a superior performance than the other two algorithms.

TABLE 3

| | K-best | SM | HM |
|---|---|---|---|
| Sim. 75% of nodes in G_{D}, σ = 0.1 | 81 | 73 | 74 |
| Sim. 50% of nodes in G_{D}, σ = 0.1 | 74 | 62 | 62 |

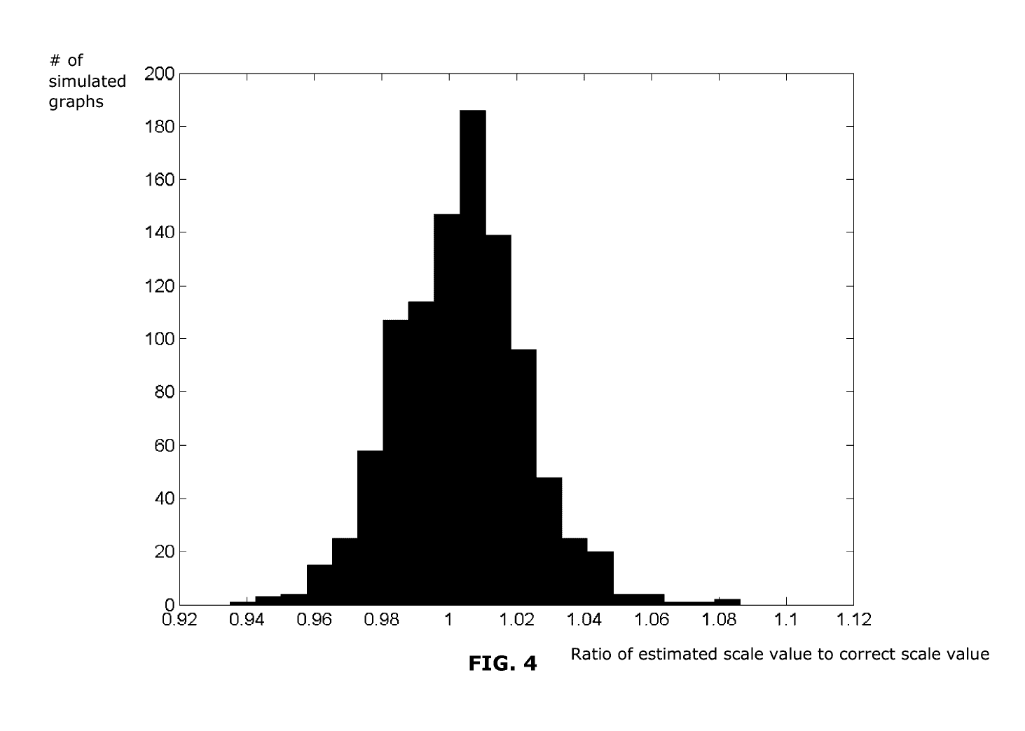

It was observed that in order for the similarity measure to have meaningful values, the graphs should have the same scaling, since G_{D} and G_{T} generally have different scales. In the examples discussed above, the normalization factor used for unifying the scales was the sum of all the pairwise shortest path distances between the nodes of each graph. This measure worked well for complete graphs, but for the partial matching case, the performance was found in some cases to be degraded by up to 70%. FIG. 4 shows the histogram of the ratio of estimated scale factor to the correct scale factor for the example 1000 simulated graphs. The means is 1.004, and the standard deviation is 0.019.

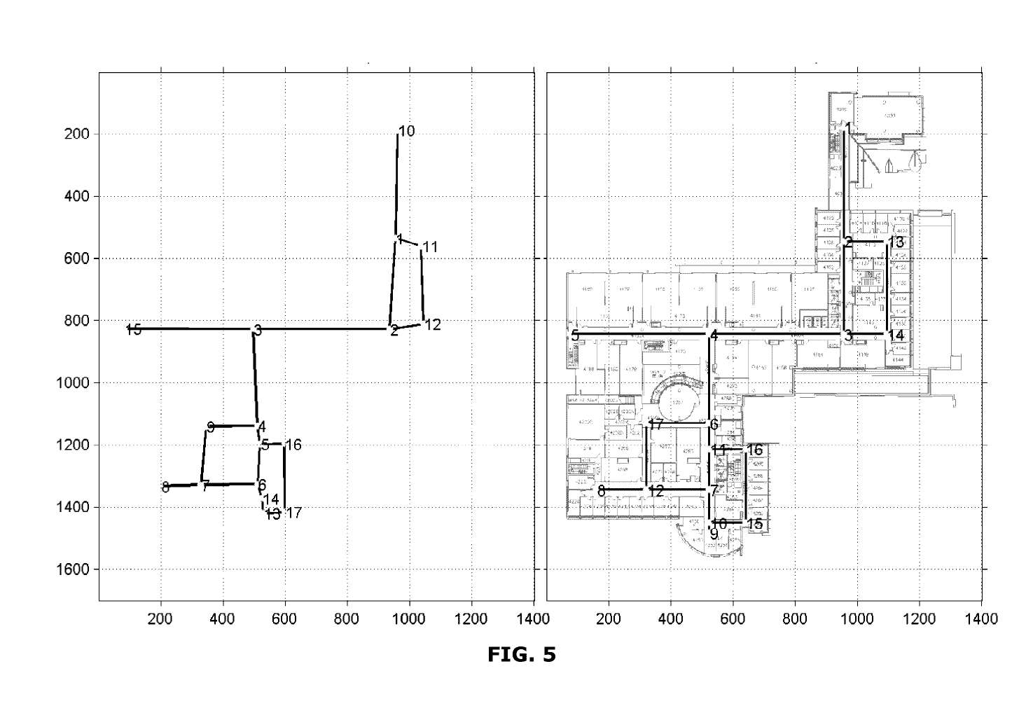

An example of the disclosed matching algorithm was also tested on real-life data. In this experiment, the ground truth graph G_{T} was manually drawn based on the floor plan of the 4th floor of the Bahen Center for Information Technology in the University of Toronto. FIG. 5 (left) shows the example filtered data graph G_{D} of the complete floor obtained from crowdsourced data, and FIG. 5 (right) shows the ground truth graph G_{T} of the complete floor matched to G_{D}.

To have a measure of how well G_{D} was generated, as well as the performance of the matching algorithms, the data graph G_{D} was built using two ways: using semi-supervised DR and using unsupervised crowdsourcing. The semi-supervised DR data graph was generated by indicating the initial location and manually correcting the estimated location of the user every 50 to 100 steps, so it was expected to be more accurate than the crowdsourced version. The locations in between were estimated via the DR module. In the unsupervised method, no location information was given to the system; only walked traces data were collected via smart-phones sensors. In both cases, the obtained traces were then processed to merge the points that overlapped based on similar Wi-Fi readings.

The example data graph obtained from crowdsourced data, shown in FIG. 5 (left), was obtained from 26 completely unsupervised walked traces. The merging algorithm was able to find the overlap of 16 traces out of the 26 traces walked in the area. It can be seen from these example results that an example implementation of the present disclosure has been able to successfully analyze and merge the traces to build a unified complete map of the building's hallways.

The average distance of the nodes of G_{D} from their corresponding node in G_{T}, due to noise, was found to be 1.2 meters and 2.2 meters for the semi-supervised and the unsupervised methods respectively, showing that the unsupervised method performs almost as well as the semi-supervised method. The error in G_{D} may be expected to be corrected by the matching algorithms.

Table 2, above, shows example results of the example disclosed K-Best algorithm, compared to the stable matching and Hungarian method algorithms, for the graphs G_{T} and G_{D}. It can be seen that the example disclosed K-Best algorithm using all pairs shortest path vector, has obtained 100% accuracy (matching all points correctly) for the semi-supervised graph and 88% accuracy (matching 15 out of 17 points correctly) for the unsupervised crowdsourced graph. After fitting the G_{D} on top of G_{T} based on the matched nodes, the average error on the location of the nodes was found to be 1.4, 1.0, 0.6 meters.

It can be seen that the example disclosed matching algorithm not only labels the nodes of G_{D}, it also reduces the error in the location of the nodes, as the 2.2 meters of error that occurred during the generation of G_{D} is reduces to 0.6 meters using the K-best fits algorithm. The performance of K-best fits using the defined similarity measure may be due to its ability to exploit the neighborhood information of the nodes in the matching.

In some examples, other matching algorithms may be used. The present disclosure also discloses an example algorithm based on hidden Markov models (HMM). In contrast to many existing approaches, the example disclosed approach works in the offline phase and has a moderate complexity (O(N³) when both graphs have O(N) nodes). Furthermore, the example disclosed matching approach can be applied to many of the existing solutions (e.g., the ones that obtain semantic pathway maps), to contribute to their accuracy by adjusting the location tags in the radio maps.

Similarly to the example disclosed K-best fits algorithm described above, the example disclosed HMM algorithm makes use of neighborhood information. While the example disclosed HMM algorithm follows a probabilistic approach for finding an optimal matching, the example disclosed K-best fits algorithm is not probabilistic. The example disclosed HMM algorithm may not require a global similarly measurement between the node pairs of the two graphs being matched. The example disclosed HMM algorithm may use the local neighborhood information of each node by looking at the number of edges connected to the node and the weights of the edges. If heading information is also available, the angle between the edges may also be used as information for identifying two matching nodes. The example K-best fits algorithm described above may not use heading information for matching, although other variations of the K-best fits algorithms may make use of the heading direction information. The example disclosed HMM may be more complex than the example disclosed K-best fits algorithm, but may produce a more accurate matching.

The hidden Markov model has been used for graph matching in several other contexts such as image processing, i.e., shape matching [48]. However, due to differences in the problem settings, the example disclosed approach uses an augmented variation of HMM with continuous emission distributions depending not only on the current state, but also on the previous states.

To match the graphs, a random sequence of nodes is generated to mimic a hypothetical user walking on G_{D}: S⁼{Sₙ}ₙ₌₁^{N}, Sₙ ε {1,2, . . . ,|U|}, where |U| is the number of nodes in G_{D}. The sequence S is a random traverse on G_{D}, with a uniform random initial node.

Once such sequence is generated, a sequence of edge weights X={Xₙ}ₙ₌₁^{N}, representing walked distances in each state transition is observed.

A sequence of relative changes in the heading direction (if available,) is also observed, while transitioning between the states. Such sequence may be referred to as Y={Yₙ}ₙ₌₁^{N}.

The principle of the example disclosed matching algorithm is that the walk (generated sequence) on G_{D}, can be considered as a walk on G_{D} that was subject to an unknown deterministic noise, that caused G_{T} be transformed into G_{D}. It should be noted that although the labeling order of the nodes in G_{T} and G_{D} are not identical, the observed edge weights and heading directions are expected to be similar in both graphs. It may be possible to compensate that deterministic noise and find the correct mapping between the nodes of G_{D} and G_{T} by observing the sequence of walked distances and relative heading directions (if available,) to find the most probable sequence of states on G_{T} that could produce the same sequence.

Once such sequence is obtained, it can be compared to the actual sequence walked on G_{D} to find a correspondence between the node pairs in the two graphs.

Define the set of nodes in G_{T} as the set of possible states, represented by the latent variable Z ε {1,2, . . . ,|V|}, where |V| is the number of nodes in G_{T}. The equivalent sequence of states in G_{T} is represented by Z={Zₙ}ₙ₌₁^{N}, with transition probabilities:

$$Pr ( {z}_{n} \vert {z}_{n - 1} ) = \{ \begin{matrix}0 & if {A}_{GT} ( {z}_{n} , {z}_{n - 1} ) = 0 \\ 1 / degree ( {z}_{n} ) & otherwise .\end{matrix} , \qquad ( 5 )$$

where zₙ represents the outcome of Zₙ, indicating the latent state at time n, A_{GT} is the adjacency matrix for the graph G_{T}, and degree(zₙ) denotes the number of states from which Zₙ can transition to, with non-zero probability.

The sequence of emissions (walked distances) are represented by X, where unlike the conventional HMMs, xₙ has a continuous probability distribution that depends on both the current state Zₙ and the previous state:

Pr(xₙ|zₙ,zₙ₋₁)˜ [symbol] (μ,σ) (6)

where N(μ,σ) denotes a Gaussian distribution with mean values set to be μ=A_{GT}(zₙ,zₙ₋₁) and standard deviation σ set according to the observations of noise in measuring the distance. For the example experiments discussed herein, σ is set at σ=0.1μ, since the variance of the noise grows as the walked distance grows, due to drift error. Note that in practice, the Gaussian distribution should be truncated for values less than zero, since xₙ represents distance. Since the distribution of emission is a function of the current, the previous state and the adjacency matrix, the equation becomes Pr(Xₙ|Zₙ, Zₙ₋₁,A_{GT})˜N(μ_{Zn,Zn-1}}, σ_{Zn,Zn-1}), where μ_{i,j}=A_{GT} (i,j).

If the heading direction information is also available, there exists an extra observation, which comprises the relative changes in the heading direction when transitioning from one state to another. Such observation can be also considered as a second element of the emission sequence X. Here, for simplicity of notations, it may be defined as a separate sequence, denoted by the random process Y={Yₙ}ₙ₊₁^{N}, Yₙ ε {0,90,−90,180}. Note that Yₙ depends on the current state, as well as the previous two states, such that

$$Pr ( {y}_{n} \vert {z}_{n} , {z}_{n - 1} , {z}_{n - 2} ) \{ \begin{matrix}1 - ε & if ∠ ( {z}_{n} , {z}_{n - 1} , {z}_{n - 2} ) = {y}_{n} \\ ε / 3 & other 3 possible cases\end{matrix} \qquad ( 7 )$$

where ε is the probability of false heading detection and <(a,b,c) denotes the angle that appears when moving from a to b and then to c. In the example experiments discussed herein, according to observations ε is set at ε=10⁻².

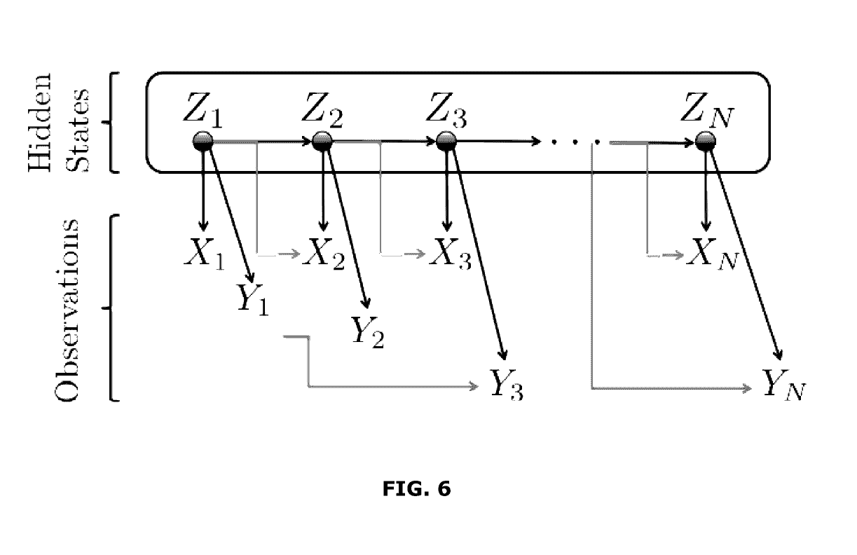

FIG. 6 shows a schematic diagram of the example modeled HMM approach. The arrows indicate dependence. Given the transition and emission probabilities, the probability of observing a sequence of emissions {X,Y}, caused by a sequence of occurred states {Z}, with model parameters Θ={A_{GT},π,ε}, where π is the prior probability of the states, can be written as

$$Pr ( X , Z , Y \vert Θ ) = Pr ( {z}_{1} \vert π ) [ {\prod }_{n = 2}^{N} Pr ( {z}_{n} \vert {z}_{n - 1} ) ] Pr ( {X}_{1} \vert {Z}_{1} ) [ {\prod }_{m = 2}^{N} Pr ( {X}_{m} \vert {Z}_{m} , {Z}_{m - 1} , {A}_{GT} ) ] Pr ( {Y}_{1} \vert {Z}_{1} ) Pr ( {Y}_{2} \vert {Z}_{2} , {Z}_{1} ) [ {\prod }_{l = 3}^{N} Pr ( {Y}_{l} \vert {Z}_{l} , … {Z}_{l - 2} , ε ) ] \qquad ( 8 )$$

Letting the initial states to be equiprobable, the most probable sequence of states on G_{T}, based on the observed sequence of emissions can be formulated as:

$$\begin{matrix}\hat{Z} = arg {max}_{Z} Pr ( Z \vert X , Y , Θ ) \\ = arg {max}_{Z} [ \begin{matrix}{\sum }_{n = 2}^{N} log Pr ( {Z}_{n} \vert {Z}_{n - 1} ) + \\ {\sum }_{m = 2}^{N} log Pr ( {X}_{m} \vert {Z}_{m} , {Z}_{m - 1} , {A}_{{𝒢}_{T}} + \\ {\sum }_{l = 3}^{N} log Pr ( {Y}_{l} \vert {Z}_{l} , {Z}_{l - 1} , {Z}_{l - 2} , ∈ )\end{matrix} ]\end{matrix} \qquad ( 9 )$$

If the direction information is unavailable, the last line of (9) will be omitted.

Using the formulation given in (9), the most probable sequence of states is calculated using the Viterbi algorithm with complexity O(|U∥V|N). If the number of the nodes of two graphs is the same order, since N is also selected to be an order of the number of nodes (so that all nodes are walked at least once,) the complexity will be O(N³).

Once \hat{Z} is calculated, a mapping table may be defined as M=[m_{i,j}], i ε {1, . . . ,|U|}, j ε {1, . . . ,|V|} by comparing the state sequences S and \hat{Z} in the following way:

initially set m_{i,j}=0, ∀ i,j;

for k=1, . . . ,N do m_{S}_{ₖ}_{,\hat{Z}}_{ₖ}=m_{S}_{ₖ}_{,\hat{Z}}_{ₖ}+1.

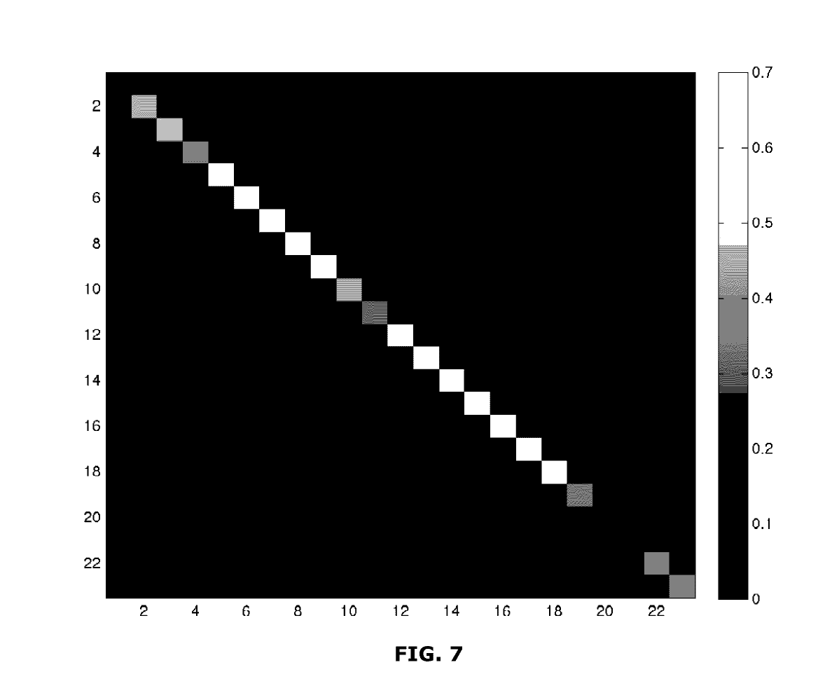

Note that if the mapping is unitary, after normalizing each row of M, the obtained table should be close to a unitary matrix (see FIG. 7, representing an example mapping table for 23 nodes and unitary mapping). Since \hat{Z} may have some errors, in order to obtain the final mapping, the stable matching algorithm [49] may be applied to map each node of G_{D} to it most stable match. If the number of nodes in G_{T} and G_{D} are not the same, one to many mappings may be allowed in the algorithm.

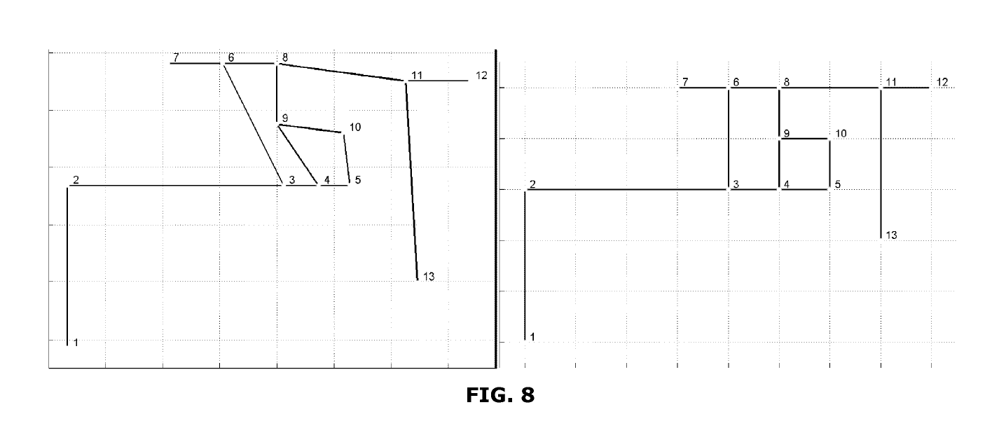

In order to validate the performance of the example modified HHM approach, 1000 rounds of graph matching were performed on simulated graphs. In each round, a random graph was generated with 20 to 40 nodes. The graphs were generated with certain structural limits, such as maximum degree of 4, single connected component, and planar, so that the graph could actually be in correspondence with an imaginary building floor. The method to generate the graphs was by simulating a random walked trace (of 60-100 steps length,) on a 2D plain, where intersections were repetitive points the trace passed along. As mentioned previously, only the intersections were kept, turning points and ending points of the trace as the graph nodes. This is equivalent to the “macro graphs” obtained in [50]. A noisy copy of the graph was also simultaneously built by adding a Gaussian noise (with σ ε {0.1, 0.2}) to each taken step of the trace to simulate the variations in the step length. An example simulated graph (with fewer than 20 nodes) is shown in FIG. 8 (right) and its noisy copy is shown in FIG. 8 (left). For assessing the robustness to heading direction noise, a possibility of detecting wrong heading direction (Pr(error)=0.05) was also added when heading direction was used for matching.

Similar to the example experiments performed for the example K-best fit algorithm, the performance of the modified HMM method was also tested for partial matching, by removing a portion of neighboring nodes in G_{D} before the matching. These cases were used to study whether the matching can perform well, when only a portion of the complete floor plan is explored by the users, and hence the pathway map G_{D} does not cover the whole floor plan. The weight normalization method for partial graph matching was observed not to work effectively and high errors in scale estimation (more than 50%) where also observed. Therefore, the results shown here for partial matching use the correct scale rather than an estimated scale. Using other more effective methods for estimating the correct scale of the weights may help to improve this.

For each matching, the example modified HMM algorithm was run 4 times with N=1000 and based on that, the mapping Table M was calculated. Table 4 below shows the results of the example simulation, compared with the example K-best fits algorithm discussed above, as well as stable matching and the Hungarian method, with all pairs shortest path similarity measure. The example results are indicated in percentage of correct assignments. Repetitive values are removed. σ=std. dev. of added noise to G_{D}. p is the probability of having wrong heading direction information

TABLE 4

| | HMM w/ dir | | HMM | | | |
|---|---|---|---|---|---|---|
| | p = 0.05 | p = 0 | w/o dir | K-best | SM | HM |
| Simulation σ = 0.1 | 100 | 100 | 96 | 98 | 97 | 97 |
| Simulation σ = 0.2 | 99 | 99 | 92 | 96 | 86 | 87 |
| Sim. 75% of nodes | 84 | 84 | 79 | 81 | 73 | 74 |
| in G_{D}, σ = 0.1 | | | | | | |
| Sim. 50% of nodes | 80 | 80 | 73 | 74 | 62 | 62 |
| in G_{D}, σ = 0.1 | | | | | | |
| Real data | — | 94 | 82 | 88 | 76 | 82 |
| (dead reckoning) | | | | | | |

It can be seen that when the direction information exists, the example HMM matching algorithm achieved 100% accuracy in matching the nodes correctly (for σ=0.1) and when the direction information is not available, the matching still has an acceptably high accuracy (96% for σ=0.1). It is also observed that the matching is robust to noise in heading directions, where for 5% of noise in heading directions, less than 1% deterioration in accuracy has occurred. The robustness of the algorithm for partial matching is also shown in Table 4.

The example HMM algorithm was also tested on real data. The ground truth graph G_{T} was manually drawn based on the 4^{th} floor of “Bahen Center of Information Technology”, at the University of Toronto.

Reference is again made to FIG. 5, which shows an example data graph (FIG. 5, left) and the example data graph matched on the building's floor plan (FIG. 5, right). The data graph G_{D} was built using dead reckoning on Samsung Galaxy™ SIII smart-phone with Android operating system. As can be seen, G_{D} is a noisy version of G_{T}. The better performance of the example HMM method in comparison to other methods may be due to effectively using the heading direction information of the pathway map in the graph. Example results for the testing on real data are shown in Table 4 above. It can be seen that the HMM matching algorithm was found to obtain 94% accuracy in matching the node pairs.

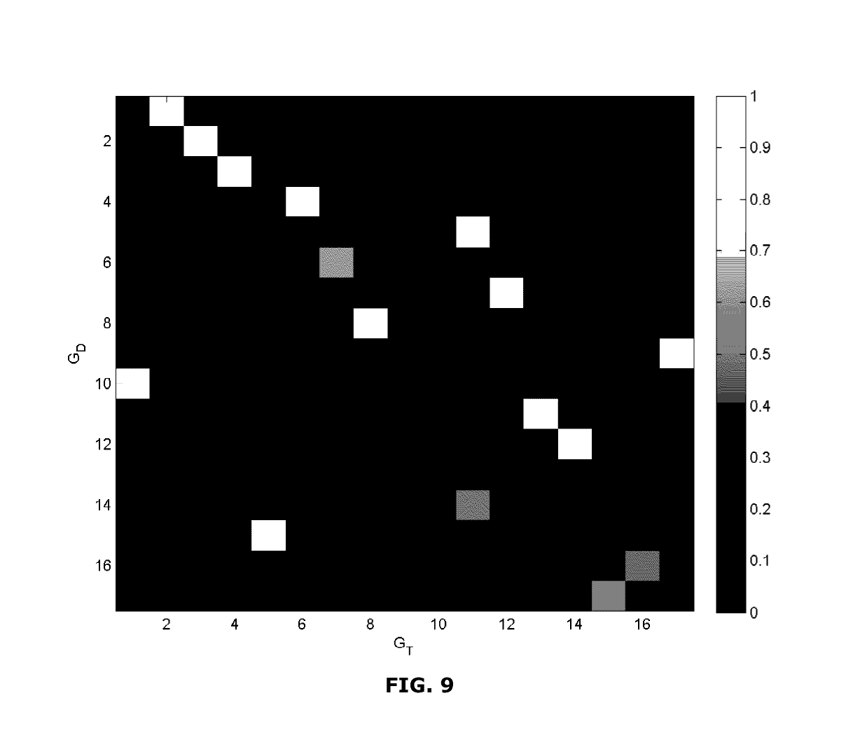

FIG. 9 shows an example obtained mapping table for the example graphs shown in FIG. 5. Although not unitary, it can be seen that most of the nodes in G_{D} can clearly recognize their correct corresponding node in G_{T} since in most of the rows of the table a single point has higher value (brighter contrast) than the rest of the points in that row. The only node that was matched incorrectly was node number 14 on G_{D}, where the two graphs look very different.

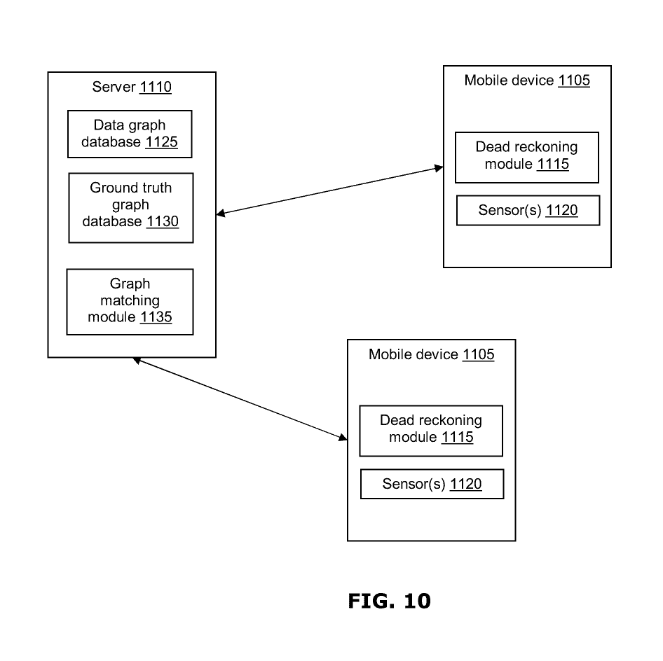

FIG. 10 is a schematic diagram of an example system 1100 that may be suitable for implementing examples of the present disclosure.

In some examples, the radio map obtained by matching the data graph to the ground truth graph may be updated as new data trace(s) become available. The updating process, which may involve repeating steps described above, including merging the new data trace(s) with the existing data graph to generate an updated data graph, and matching the updated data graph with the ground truth graph to generate the updated radio map, may take place once a predetermined number of new traces are received or a predetermined time duration has passed, for example.

The system 1100 may include multiple mobile devices 1105 (which may be used by different respective users) in wireless connection (e.g., via a wireless network, such as a WLAN) with at least one server 1110. Each of the mobile devices 1105 may be configured to perform the data gathering using a dead reckoning (DR) module 1115, for example as described above. The DR module 1115 may receive information (e.g., acceleration information) about the mobile device 1105 from one or more sensors 1120 (e.g., accelerometer, gyroscope and/or other inertial sensor) of the mobile device 1105. The DR module 1115 may use the received information to perform step counting, for example as discussed above, in order to generate a data graph for that mobile device 1105, as the user walks inside a building.

The generated raw data traces from each mobile device 1105 may be communicated to the server(s) 1110, and the server(s) 1110 may store the raw data traces, and the subsequently generated crowdsourced data graph, in a data graph database 1125 (which may be in local memory(ies) of the server(s) 1110 or may be in remote memory(ies) accessible by the server(s) 1110). The server(s) 1110 may also have a ground truth graph for the building of interest stored in a ground truth graph database 1130 (which may be in local memory(ies) of the server(s) 1110 or may be in remote memory(ies) accessible by the server(s) 1110). The ground truth graph may be provided to the ground truth graph database 1130 ahead of time, for example by an administrator inputting a floor plan into the server(s) 1110.

The server(s) 1110 may use a graph matching module 1135 to carrying out the example graph matching processes described above (e.g., to aggregate raw data traces from individual mobile devices with each other to generate the crowdsourced data graph, and to match the crowdsourced data graph to the ground truth graph). The graph matching module 1135 may be configured to implement any of the example graph matching algorithms disclosed herein (e.g., K-best fit algorithm or HMM algorithm), including variations thereof, and/or other suitable graph matching algorithms, for example. In some examples, the graph matching module 1135 may provide a setting to select which graph matching algorithm to use.

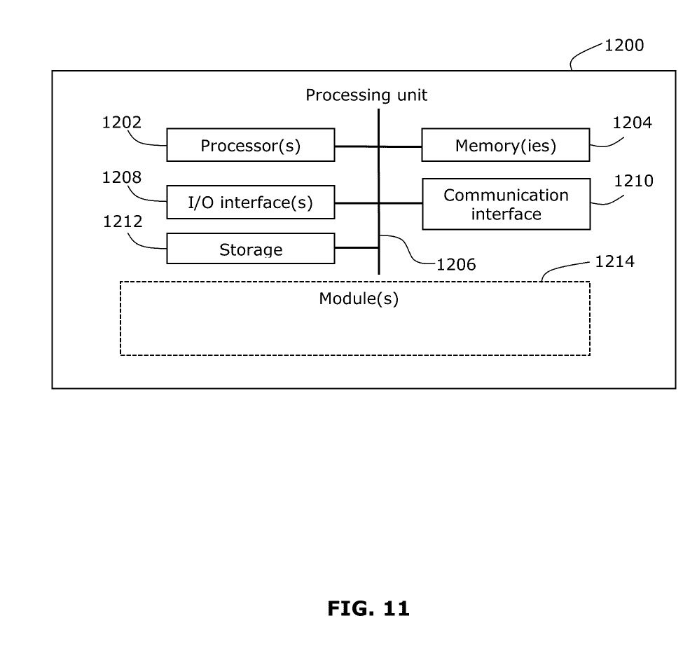

FIG. 11 is a schematic diagram illustrating an example processing unit 1200 that may be used to implement the server(s) 1110 and/or mobile devices 1105 discussed above (with suitable modifications where appropriate), and that may be used to carry out examples of the present disclosure.

In some examples, the processing unit 1200 may include one or more processors 1202 (for example, a CPU and/or microprocessor), one or more memories 1204 (which may include random access memory (RAM) and/or read-only memory (ROM)), a system bus 1206, one or more input/output interfaces 1208 (such as a user interface for a user to provide various inputs), one or more communications interfaces 1210 (e.g., to communication with other server(s), mobile device(s) and/or remote data storage), and one or more internal storage devices 1212 (e.g. a hard disk drive, compact disk drive and/or internal flash memory). The processing unit 1200 may also include a power supply (not shown).

The processing unit 1200 may interface with one or more other external devices (not shown), such as external input and/or output devices which may include, for example, one or more of a display, keyboard, mouse, microphone and speaker.

Various embodiments and aspects of the present disclosure may be implemented via the processor(s) 1202 and/or memory(ies) 1204. For example, one or more of the functionalities and methods described herein may be at least partially implemented via hardware logic in the processor(s) 1202 and/or at least partially using instructions stored in the memory(ies) 1204, as one or more modules 1214. For example, where the processing unit 1200 is used to implement the server 1110, the module(s) 1214 may include the graph matching module 1135. In another example, where the processing unit 1200 is used to implement the mobile device 1105, the module(s) 1214 may include the dead reckoning module 1115. Although certain modules are described, it should be understood that modules need not be specifically defined in the instructions, a plurality of modules may work together to carry out a function, and a module may be used to implement any combination of functions.

Variations and modifications may be made as appropriate. For example, one or more components of the processing unit 1200 may be provided as an external component or device. Although only one of each component is illustrated in FIG. 11, any number of each component can be included. For example, a computer typically contains a number of different data storage media. Furthermore, although the bus 1206 is depicted as a single connection between all of the components, the bus 1206 may represent one or more circuits, devices or communication channels which link two or more of the components. For example, in personal computers, the bus 1206 may include or may be a motherboard.

Some embodiments or aspects of the present disclosure may be implemented using the processor(s) 1202 without additional instructions stored in the memory 1204. Some embodiments or aspects of the present disclosure may be implemented using instructions stored in the memory 1204 for execution by one or more general purpose microprocessors. In some examples, the processing unit 1200 may be, or may include, a general purpose computer or any other hardware equivalents configured for operation in space. The processing unit 1200 may also be implemented as one or more physical devices that may be coupled to the processor(s) 1202 through one or more communications channels or interfaces. The present disclosure is not limited to a specific configuration of hardware and/or software.

In various examples, the present disclosure addresses the problem of effort-free or reduced-effort radio map generation for RSS-based indoor localization. Unlike many conventional techniques, the example disclosure method may not require any active user intervention during the training. The system may automatically collect data from sensors in the mobile device (e.g., inertial sensors) along with Wi-Fi signals and may build a radio map by merging the collected data from multiple users, who may be engaged in their daily activities. The problem may be modeled as a matching of weighted undirected graphs based on a defined similarity measure for graphs. In some examples, the present disclosure provides example algorithms to solve it. In some examples, the present disclosure also provides a technique to calculate the similarity measurement efficiently.

The embodiments of the present disclosure described above are intended to be examples only. The present disclosure may be embodied in other specific forms. Alterations, modifications and variations to the disclosure may be made without departing from the intended scope of the present disclosure. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

### REFERENCES

[1] Android documentation of motion sensors. http://developer.android.com/guide/topics/sensors/sensors_motion.html. Accessed: 2010-09-30.
[2] P. Bahl and V. Padmanabhan. Radar: an in-building RF-based user location and tracking system. In INFOCOM 2000. Nineteenth Annual Joint Conference of the IEEE Computer and Communications Societies. Proceedings. IEEE, volume 2, pages 775-784 vol. 2, 2000.
[3] S. Belongie, J. Malik, and J. Puzicha. Shape matching and object recognition using shape contexts. IEEE Trans. Pattern Anal. Mach. Intell., 24(4):509-522, April 2002.
[4] J. A. Bondy and U. S. R. Murty. Graph theory with applications, volume 290. Macmillan London, 1976.
[5] D. Conte, P. Foggia, C. Sansone, and M. Vento. Thirty years of graph matching in pattern recognition. International journal of pattern recognition and artificial intelligence, 18(03):265-298, 2004.
[6] J. Edmonds and R. M. Karp. Theoretical improvements in algorithmic efficiency for network flow problems. Journal of the ACM (JACM), 19(2):248-264, 1972.
[7] L. Fang, P. Antsaklis, L. Montestruque, M. McMickell, M. Lemmon, Y. Sun, H. Fang, I. Koutroulis, M. Haenggi, M. Xie, and X. Xie. Design of a wireless assisted pedestrian dead reckoning system—the navmote experience. IEEE Trans. Instrum. Meas., 54(6):2342-2358, December 2005.
[8] C. Feng, W. Au, S. Valaee, and Z. Tan. Received-signal-strength-based indoor positioning using compressive sensing. IEEE Trans. Mobile Comput., 11(12):1983-1993, 2012.
[9] B. Ferris, D. Fox, and N. D. Lawrence. Wifi-slam using gaussian process latent variable models. In IJCAI, volume 7, pages 2480-2485, 2007.
[10] D. Gale and L. S. Shapley. College admissions and the stability of marriage. The American Mathematical Monthly, 69(1):9-15, 1962.
[11] P. L. Jenkins, T. J. Phillips, E. J. Mulberg, and S. P. Hui. Activity patterns of californians: use of and proximity to indoor pollutant sources. Atmospheric Environment. Part A. General Topics, 26(12):2141-2148, 1992.
[12] Y. Jin, M. Motani, W.-S. Soh, and J. Zhang. Sparsetrack: Enhancing indoor pedestrian tracking with sparse infrastructure support. In INFOCOM, 2010 Proceedings IEEE, pages 1-9, 2010.
[13] M. Kanaan and K. Pahlavan. A comparison of wireless geolocation algorithms in the indoor environment. In Wireless Communications and Networking Conference, 2004. WCNC. 2004 IEEE, volume 1, pages 177-182 Vol. 1, 2004.
[14] S. Kantawong. Development of fire evacuation path selective using adaptive routing algorithms and rfid traffic cone-based observation with shadowing method. In Electrical Engineering/Electronics, Computer, Telecommunications and Information Technology (ECTI-CON), 2012 9th International Conference on, pages 1-4, 2012.
[15] Y. Kim, Y. Chon, and H. Cha. Smartphone-based collaborative and autonomous radio fingerprinting. IEEE Trans. Syst., Man, Cybern. C, 42(1):112-122, January 2012.
[16] M. B. Kjaergaard. A taxonomy for radio location fingerprinting. In Location- and Context-Awareness, pages 139-156. Springer, 2007.
[17] H. W. Kuhn. The Hungarian method for the assignment problem. Naval research logistics quarterly, 2(1-2):83-97, 1955.
[18] Q. Ladetto. On foot navigation: continuous step calibration using both complementary recursive prediction and adaptive kalman filtering. In Proceedings of ION GPS, volume 2000, pages 1735-1740, 2000.
[19] H. Liu, H. Darabi, P. Banerjee, and J. Liu. Survey of wireless indoor positioning techniques and systems. IEEE Trans. Syst., Man, Cybern. C, 37(6):1067-1080, 2007.
[20] R. Ouyang, A. Wong, C.-T. Lea, and M. Chiang. Indoor location estimation with reduced calibration exploiting unlabeled data via hybrid generative/discriminative learning. IEEE Trans. Mobile Comput., 11(11):1613-1626, 2012.
[21] J. Pinchin, C. Hide, and T. Moore. A particle filter approach to indoor navigation using a foot mounted inertial navigation system and heuristic heading information. In Indoor Positioning and Indoor Navigation (IPIN), 2012 International Conference on, pages 1-10, 2012.
[22] A. Rai, K. K. Chintalapudi, V. N. Padmanabhan, and R. Sen. Zee: Zero-effort crowdsourcing for indoor localization. In Proceedings of the 18th annual international conference on Mobile computing and networking, pages 293-304. ACM, 2012.
[23] C. Randell, C. Djiallis, and H. Muller. Personal position measurement using dead reckoning. In Wearable Computers, 2003. Proceedings. Seventh IEEE International Symposium on, pages 166-173, 2003.
[24] G. Shen, Z. Chen, P. Zhang, T. Moscibroda, and Y. Zhang. Walkie-markie: indoor pathway mapping made easy. In Proc. of USENIX NSDI, 2013.
[25] H. Shin and H. Cha. Wi-fi fingerprint-based topological map building for indoor user tracking. In Int. Conf. on Embedded and Real-Time Computing Syst. and Applicat. (RTCSA), 2010 IEEE 16th, pages 105-113, August 2010.
[26] H. Shin, Y. Chon, and H. Cha. Unsupervised construction of an indoor floor plan using a smartphone. IEEE Trans. Syst., Man, Cybern. C, 42(6):889-898, November 2012.
[27] D. Simchi-Levi, X. Chen, and J. Bramel. Convexity and supermodularity. In The Logic of Logistics, Springer Series in Operations Research, pages 13-32. Springer New York, 2005.
[28] H. Wang, H. Lenz, A. Szabo, J. Bamberger, and U. Hanebeck. Wlan-based pedestrian tracking using particle filters and low-cost MEMS sensors. In Positioning, Navigation and Communication, 2007. WPNC '07. 4th Workshop on, pages 1-7, 2007.
[29] H. Wang, S. Sen, A. Elgohary, M. Farid, M. Youssef, and R. R. Choudhury. No need to war-drive: unsupervised indoor localization. In Proceedings of the 10th international conference on Mobile systems, applications, and services, pages 197-210. ACM, 2012.
[30] D. B. West et al. Introduction to graph theory, volume 2. Prentice hall Englewood Cliffs, 2001.
[31] O. Woodman and R. Harle. RF-based initialisation for inertial pedestrian tracking. In Pervasive Computing, pages 238-255. Springer, 2009.
[32] C. Wu, Z. Yang, Y. Liu, and W. Xi. Will: Wireless indoor localization without site survey. IEEE Trans. Parallel Distrib. Syst., 24(4):839-848, April 2013.
[33] Z. Yang, C. Wu, and Y. Liu. Locating in fingerprint space: wireless indoor localization with little human intervention. In Proceedings of the 18th annual international conference on Mobile computing and networking, pages 269-280. ACM, 2012.
[34] L. Zager. Graph similarity and matching. PhD thesis, Massachusetts Institute of Technology, 2005.
[35] S. Fortin, “The graph isomorphism problem,” Technical Report 96-20, University of Alberta, Edomonton, Alberta, Canada, Tech. Rep., 1996.
[36] H. Bunke, X. Jiang, and A. Kandel, “On the minimum common supergraph of two graphs,” Computing, vol. 65, no. 1, pp. 13-25, 2000.
[37] S. Belongie, J. Malik, and J. Puzicha, “Shape matching and object recognition using shape contexts,” IEEE Trans. Pattern Anal. Mach. Intell., vol. 24, no. 4, pp. 509-522, April 2002.
[38] H. Sundar, D. Silver, N. Gagvani, and S. Dickinson, “Skeleton based shape matching and retrieval,” in Shape Modeling International, 2003, May 2003, pp. 130-139.
[39] V. D. Blondel, A. Gajardo, M. Heymans, P. Senellart, and P. Van Dooren, “A measure of similarity between graph vertices: Applications to synonym extraction and web searching,” SIAM review, vol. 46, no. 4, pp. 647-666, 2004.
[40] M. Heymans and A. K. Singh, “Deriving phylogenetic trees from the similarity analysis of metabolic pathways,” Bioinformatics, vol. 19, no. suppl 1, pp. i138-i146, 2003.
[41] D. Conte, P. Foggia, C. Sansone, and M. Vento, “Thirty years of graph matching in pattern recognition,” International journal of pattern recognition and artificial intelligence, vol. 18, no. 03, pp. 265-298, 2004.
[42] P. Bahl and V. Padmanabhan, “Radar: an in-building RF based user location and tracking system,” in INFOCOM 2000. Nineteenth Annual Joint Conference of the IEEE Computer and Communications Societies. Proceedings. IEEE, vol. 2, 2000, pp. 775-784 vol. 2.
[43] H. Shin, Y. Chon, and H. Cha, “Unsupervised construction of an indoor floor plan using a smartphone,” IEEE Trans. Syst., Man, Cybern. C, vol. 42, no. 6, pp. 889-898, November 2012.
[44] H. Shin and H. Cha, “Wi-fi fingerprint-based topological map building for indoor user tracking,” in Int. Conf. on Embedded and Real-Time Computing Syst. and Applicat. (RTCSA), 2010 IEEE 16th, August 2010, pp. 105-113.
[45] Y. Kim, Y. Chon, and H. Cha, “Smartphone-based collaborative and autonomous radio fingerprinting,” IEEE Trans. Syst., Man, Cybern. C, vol. 42, no. 1, pp. 112-122, January 2012.
[46] A. Rai, K. K. Chintalapudi, V. N. Padmanabhan, and R. Sen, “Zee: Zero-effort crowdsourcing for indoor localization,” in Proceedings of the 18th annual international conference on Mobile computing and networking. ACM, 2012, pp. 293-304.
[47] J. Pinchin, C. Hide, and T. Moore, “A particle filter approach to indoor navigation using a foot mounted inertial navigation system and heuristic heading information,” in Indoor Positioning and Indoor Navigation (IPIN), 2012 International Conference on, 2012, pp. 1-10.
[48] X. Qian and B.-J. Yoon, “Shape matching based on graph alignment using hidden markov models,” in IEEE International Conference on Acoustics Speech and Signal Processing (ICASSP), March 2010, pp. 934-937.
[49] D. Gale and L. S. Shapley, “College admissions and the stability of marriage,” The American Mathematical Monthly, vol. 69, no. 1, pp. 9-15, 1962.
[50] S. Shahidi and S. Valaee, “Graph matching for crowdsourced data in mobile sensor networks,” in IEEE 15th International Workshop on Signal Processing Advances in Wireless Communications (SPAWC), June 2014, pp. 414-418.
[51] H. W. Kuhn, “The hungarian method for the assignment problem,” Naval research logistics quarterly, vol. 2, no. 1-2, pp. 83-97, 1955.
[52] J. A. Leech, et al., “The Canadian Human Activity Pattern Survey: report of methods and population surveyed,” Chronic Diseases in Canada, 17(3-4):118-123, 1996.

1. A method for generating a map for indoor localization, the method comprising:
receiving a plurality of raw data traces from a respective plurality of mobile devices, the raw data traces representing paths traversed by the mobile devices and including received signal strength (RSS) fingerprints associated with relative points along the paths;
merging the plurality of raw data traces to generate a single data graph having a first plurality of nodes connected by a first plurality of edges;
matching the data graph with a predefined ground truth graph defining physical coordinates of traversable paths, the ground truth graph having a second plurality of nodes connected by a second plurality of edges; and
generating a radio map including both the defined physical coordinates and RSS fingerprints associated with the physical coordinates.

2. The method of claim 1, wherein matching the data graph with the predefined ground truth graph comprises matching the first plurality of nodes of the data graph with the second plurality of nodes of the predefined ground truth graph using a graph matching algorithm that takes into account neighborhood information for the first plurality of nodes of the data graph and the second plurality of nodes of the predefined ground truth graph.

3. The method of claim 2, further comprising:
prior to matching the data graph with the predefined ground truth graph, pre-processing each of the data graph and the predefined ground truth graph to reduce the number of nodes in each graph to be matched.

4. The method of claim 1, wherein merging the plurality of raw data traces comprises:
transforming the raw data traces to share a common coordinate system; and
merging the transformed data traces, wherein points of two data traces that have a distance between them that is less than a predefined threshold are merged into a single point.

5. The method of claim 1, further comprising:
receiving a new raw data trace;
merging the new raw data trace with the generated data graph to generate an updated data graph; and
matching the updated data graph with the ground truth graph, to generate an updated radio map.

6. The method of claim 1, wherein the ground truth graph comprises a predefined floor plan.

7. A system for generating a map for indoor localization, the system comprising a processor configured to execute instructions to cause the system to:
receive a plurality of raw data traces from a respective plurality of mobile devices, the raw data traces representing paths traversed by the mobile devices and including received signal strength (RSS) fingerprints associated with relative points along the paths;
merge the plurality of raw data traces to generate a single data graph having a first plurality of nodes connected by a first plurality of edges;
match the data graph with a predefined ground truth graph defining physical coordinates of traversable paths, the ground truth graph having a second plurality of nodes connected by a second plurality of edges; and
generate a radio map including both the defined physical coordinates and RSS fingerprints associated with the physical coordinates.

8. The system of claim 7, wherein the processor is further configured to execute instructions to further cause the system to match the data graph with the predefined ground truth graph by: matching the first plurality of nodes of the data graph with the second plurality of nodes of the predefined ground truth graph using a graph matching algorithm that takes into account neighborhood information for the first plurality of nodes of the data graph and the second plurality of nodes of the predefined ground truth graph.

9. The system of claim 8, wherein the processor is further configured to execute instructions to further cause the system to:
prior to matching the data graph with the predefined ground truth graph, pre-process each of the data graph and the predefined ground truth graph to reduce the number of nodes in each graph to be matched.

10. The system of claim 7, wherein the processor is further configured to execute instructions to further cause the system to merge the plurality of raw data traces by:
transforming the raw data traces to share a common coordinate system; and
merging the transformed data traces, wherein points of two data traces that have a distance between them that is less than a predefined threshold are merged into a single point.

11. The system of claim 8, wherein the processor is further configured to execute instructions to further cause the system to:
receive a new raw data trace; and
merge the new raw data trace with the generated data graph.

12. The system of claim 8, wherein the ground truth graph comprises a predefined floor plan.

13. A method for gathering received signal strength (RSS) fingerprint data, the method comprising:
while traversing a path, detecting a RSS fingerprint;
absent a predefined starting point of the path and absent information about an orientation of the system relative to the path, determining a relative position along the path associated with the RSS fingerprint, the relative position being determined based on cumulative displacement and heading direction relative to a relative starting point;
repeating the detecting and determining until an end point is reached;
generating a raw data trace including all detected RSS fingerprints associated with respective relative points along the path; and
transmitting the raw data trace to a central server.

14. The method of claim 13, wherein determining the relative position along the path comprises:
determining the cumulative displacement using a count of steps since the relative starting point and an estimate of step length; and
determining the heading direction using cumulative changes in heading since the relative starting point.

15. The method of claim 13, wherein signals from at least one of an accelerometer and a gyroscope are used to determine the relative position along the path.
